(19) United States
(12) Patent Application Publication
(10) Pub. No.: US 2009/0093314 A1
(43) Pub. Date: Apr. 9, 2009

(54) Game program and game apparatus

(75) Inventor: Mikito Ichikawa, Tokyo (JP)

Correspondence Address: NIXON & VANDERHYE, P.C., 901 NORTH GLEBE ROAD, 11TH FLOOR, ARLINGTON, VA, 22203, US

(73) Assignee: Nintendo Co., Ltd., Kyoto (JP)

(21) Appl. No.: 12/073,753

(22) Filed: Mar. 10, 2008

(30) Foreign Application Priority Data
Oct. 5, 2007 (JP) 2007-262600

(51) Int. Cl. G06F 17/00

(52) U.S. Cl. 463/43; 463/16

(57) ABSTRACT

A game apparatus can executes a plurality of game processing in parallel. The CPU of the game apparatus executes first game processing out of the plurality of game processing on the basis of first operation data to display a result at a first area, executes second game processing as another one on the basis of second operation data to display a result at a second area, and exerts an influence on the basis of the execution result of the first game processing on the second area on which the execution result of the second game processing is displayed. Here, one of the first operation data and the second operation data may be real-time operation data, and the other one may be replay operation data.

### CROSS REFERENCE OF RELATED APPLICATION

The disclosure of Japanese Patent Application No. 2007-262600 is incorporated herein by reference.

### BACKGROUND OF THE INVENTION

1. Field of the Invention

The present invention relates to a game program and a game apparatus. More specifically, the present invention relates to a game program and a game apparatus capable of playing a game by two or more persons.

2. Description of the Related Art

One example of such kind of a program and an apparatus is disclosed in Japanese Patent Application Laid-Open No. 2007-83071 (Patent Document 1). In the related art, a common game (beat'-em-up game) is played by two persons.

Furthermore, another example is disclosed in Japanese Patent Application Laid-Open No. 2004-105221 (Patent Document 2). In this related art also, a common game (Igo game) is played by two persons, but one of the two persons is a real player (hereinafter, simply referred to as “player”) and the other thereof is a virtual player (computer).

However, each of the Patent Document 1 and the Patent Document 2 discloses a method of playing a common game by two persons (that is, player-versus-player or player-versus-computer), but does not disclose a method of independently playing games by two persons. On the other hand, in a case that two persons play separate games, there is a problem of lacking enjoyment of playing a game by two persons.

Furthermore, the Patent Document 2 discloses a method of playing a game with a virtual player who is a different person from himself, but this is not a game play with a real player, resulting in lack of enjoyment by a multi-person play. In addition, the disclosure in each the above-described Documents 1 and 2 recites a play with other players and other computers, and does not recite a novel idea of playing a game with the player himself.

### SUMMARY OF THE INVENTION

Therefore, it is a primary object of the present invention to provide a novel game program and a game apparatus.

Another object of the present invention is to provide a game program and a game apparatus which allows a plurality of players to independently play games and to exert an influence on one from another.

A still another object of the present invention is to provide a game program and a game apparatus which allows a player to sense a feeling of playing a game with other players even if the player plays the game by himself or herself.

A further object of the present invention is to provide a novel game program and a game apparatus which allows a player to sense a feeling of playing with the player himself or herself.

The present invention employs following features in order to solve the above-described problems. It should be noted that reference numerals inside the parentheses and supplement show one example of a corresponding relationship with the embodiments described later for easy understanding of the present invention, and do not limit the present invention.

A first invention is a game program to be executed by a computer of a game apparatus to display a game screen corresponding to game processing on a display area of a display, and the game program causes the computer to execute: a display area setting step for setting at least two areas of a first area for displaying a game space of a first game and a second area for displaying a game space of a second game on the display area and defining a first local coordinate system in the game space of the first area and a second local coordinate system in the game space of the second area; a second game processing step for performing predetermined game processing in the second game to decide coordinates in the second local coordinate system as to a second game object being a predetermined object within the game space; a first position transforming step for transforming the position of the second game object in the second local coordinate system into a position in a world coordinate system to be defined on the display area; a second position transforming step for transforming the position of the second game object in the world coordinate system into a position in the first local coordinate system; a determining step for determining the position of the second game object is at the first area; a first game processing step for performing game processing such that the first game is affected by the second game object which is determined to be at the first area by the determining step on the basis of the position in the first local coordinate system; a displaying step for displaying the game space of the first game at the first area, and the game space of the second game at the second area.

In the first invention, a game program causes a computer (40, 40A) of a game apparatus (12, 12A) displaying a game screen corresponding to game processing on a display area of the display (28, 28A, 28B) to execute a display area setting step (S5), a second game processing step (S37, S41), a first position transforming step (S65), a second position transforming step (S31), a determining step (S33), a first game processing step (S35), and a displaying step (S47).

The display area setting step sets at least two areas of a first area for displaying a game space of a first game and a second area for displaying a game space of a second game on the display area and defining a first local coordinate system in the game space of the first area and a second local coordinate system in the game space of the second area. The second game processing step performs predetermined game processing in the second game to decide coordinates in the second local coordinate system as to a second game object being a predetermined object within the game space. The first position transforming step transforms the position of the second game object in the second local coordinate system into a position in a world coordinate system to be defined on the display area. The second position transforming step transforms the position of the second game object in the world coordinate system into a position in the first local coordinate system. The determining step determines the position of the second game object is at the first area. The first game processing step performs game processing such that the first game is affected by the second game object which is determined to be at the first area by the determining step on the basis of the position in the first local coordinate system. The displaying step displays the game space of the first game at the first area, and the game space of the second game at the second area.

A second invention is dependent on the first invention, wherein the display area setting step changes at least one of a positional relation between the first area and the second area and a magnitude relation between the first area and the second area on the basis of an execution result of the first game processing step and an execution result of the second game processing step, and changes a corresponding relation between the first and second local coordinates and the world coordinate in accordance with the change.

A third invention is dependent on the first invention, wherein the game processing in the first game processing step is executed on the basis of first operation data for a game operation, and the game processing in the second game processing step is executed on the basis of second operation data for a game operation.

A fourth invention is dependent on the third invention, wherein the first operation data is real-time operation data to be input by a user's operation, and the second operation data is replay operation data stored in a storage medium for advancing a game in place of the user's operation.

A fifth invention is dependent on the fourth invention, wherein the program causes the computer to further execute a storing step for storing the real-time operation data as the replay operation data in the storage medium.

In the fifth invention, the program causes the computer to further execute a storing step (S43). The storing step stores the real-time operation data as the replay operation data in the storage medium.

A sixth invention is dependent on the fifth invention, wherein the program causes the computer to further execute a communicating step for transmitting and receiving replay operation data with other game apparatus via a communication means.

In the sixth invention, the program causes the computer to further execute a communicating step. The communicating step transmits and receives replay operation data with other game apparatus via a communication means (50, 136, 120).

A seventh invention is dependent on the first invention, wherein the display area further comprises a first screen and a second screen, and the first area and the second area respectively correspond to the first screen and the second screen.

An eighth invention is dependent on the first invention, wherein the first game processing step further decides coordinates in the first local coordinate system as to a first game object being a predetermined object within a game space, the first position transforming step further transforms the position of the first game object in the first local coordinate system into a position in a world coordinate system defined on the display area, the second position transforming step further transforms the position of the first game object in the world coordinate system into a position in the second local coordinate system, the determining step further determines the position of the first game object is at the second area, and the second game processing step further executes performing game processing such that the second game is affected by the first game object which is determined to be at the second area by the determining step on the basis of the position in the second local coordinate system.

A ninth invention is dependent on the eighth invention, wherein the display area setting step further sets a k-th area for displaying a game space of a k-th (k is a natural numeral equal to or more than three) game on the display area, and defines a k-th local coordinate system at the k-th area in the game space, and the game program causes the computer to further execute k-th game processing step for performing predetermined game processing in the k-th game.

A tenth invention is a game apparatus (12,12A) displaying a game screen corresponding to game processing on a display area of a display (28, 28A, 28B), and comprises a display area setting means (S5) for setting at least two areas of a first area for displaying a game space of a first game and a second area for displaying a game space of a second game on the display area and respectively defining the game spaces as first and second local coordinate systems, a second game processing means (S37, S41) for performing predetermined game processing in the second game to decide coordinates in the second local coordinate system as to a second game object being a predetermined object within the game space, a first position transformation means (S65) for transforming the position of the second game object in the second local coordinate system into a position in a world coordinate system to be defined on the display area, a second position transformation means (S31) for transforming the position of the second game object in the world coordinate system into a position in the first local coordinate system, a determining means (S33) for determining the position of the second game object is at the first area, a first game processing means (S35) for performing game processing such that the second game is affected by the second game object which is determined to be at the first area by the determining means on the basis of the position in the first local coordinate system, and a displaying means (S47) for displaying the game space of the first game at the first area and the game space of the second game at the second area.

A game program according to an eleventh invention causes a computer of a processing apparatus capable of executing a plurality of game processing in parallel to execute: a first processing step for executing first game processing as one of the plurality of game processing on the basis of first operation data and displaying an execution result at a first area; a second processing step for executing second game processing as another one of the plurality of game processing on the basis of second operation data and displaying an execution result at a second area; and an affecting step for exerting an influence on the basis of the execution result of the first game processing by the first processing step on the second area at which the execution result of the second game processing by the second processing step is displayed.

In the eleventh invention, a processing apparatus (12, 12A) can execute a plurality of game processing in parallel, and the game program causes a computer (40, 40A) of the processing apparatus to execute a first processing step (S7), a second processing step (S9), and an affecting step (S13).

The first processing step executes first game processing as one of the plurality of game processing on the basis of first operation data, and displays a execution result at a first area (W1). The second processing step executes second game processing as another one of the plurality of game processing on the basis of second operation data, and displays an execution result at a second area (W2). An influence of the execution result of the first game processing by the first processing step is exerted within the second area at which the execution result of the second game processing by the second processing step is displayed through the affecting step.

According to the eleventh invention, since an influence on the basis of the execution result of the first game processing is exerted on the second area on which the execution result by the second game processing is displayed, an influence of any one of the plurality of game processing can be exerted on another one of the game processing, that is, it is possible to exert an influence among the game processing.

A game program according to a twelfth invention is dependent on the eleventh invention, and each of the first area and the second area is a part of a common screen, the common screen is brought into association with a world coordinate system, the first area is brought into association with a first local coordinate system, and the second area is brought into association with a second local coordinate system.

In the twelfth invention, within a common screen (28) which is brought into association with a world coordinate system (X-Y coordinate system), a first area which is brought into association with a first local coordinate system (x1-y1 coordinate system) and a second area which is brought into association with a second local coordinate system (x2-y2 coordinate system) are arranged.

A game program according to a thirteenth invention is dependent on the twelfth invention, wherein the execution result of the first processing step includes position data of an affecting object to be displayed on the second area, the affecting step includes a first transforming step for performing first transformation processing from the first local coordinate system to the world coordinate system on the position data, and the second processing step includes a second transforming step for performing second transformation processing from the world coordinate system to the second coordinate system on the position data after the first transformation processing.

In the thirteenth invention, the execution result of the first processing step includes position data of an affecting object to be displayed on the second area. That is, the influence of the execution result of the first processing step is exerted on the second area by the affecting object being displayed at the second area. At this time, the first transformation processing from the first local coordinate system to the world coordinate system is performed on the position data by a first transforming step (S65), and the second transformation processing from the world coordinate system to the second coordinate system is performed on the position data on which the first transformation processing has been performed by a second processing step (S31).

According to the thirteenth invention, it is possible to exert an influence between the display areas according to the different local coordinate systems.

A game program according to a fourteenth invention is dependent on the eleventh or the thirteenth invention, wherein the program causes the computer to execute a changing step for changing at least one of a positional relation between the first area and the second area and a magnitude relation between the first area and the second area on the basis of the execution result by the first processing step and the execution result by the second processing step.

In the fourteenth invention, any one of a positional relation between the first area and the second area and a magnitude relation between the first area and the second area is changed by a changing step (S5) on the basis of the execution result by the first processing step and the execution result by the second processing step.

According to the fourteenth invention, as a result of an influence on the basis of the game result, the change of the positional relation between the areas and/or the change of the magnitude relation between the areas are added, capable of increasing enjoyment of a parallel play.

A game program according to a fifteenth invention is dependent on any one of the eleventh to fourteenth inventions, wherein one of the first operation data and the second operation data is real-time operation data on the basis of a current operation, and the other one of the first operation data and the second operation data is replay operation data on the basis of a past operation.

In the fifteenth invention, one of the first processing and the second processing is performed on the basis of real-time operation data, and the other one of the first processing and the second processing is performed on the basis of replay operation data.

According to the fifteenth invention, the player can play a game with a player who existed in the past.

A game program according to a sixteenth invention is dependent on the fifteenth invention, wherein the current operation and the past operation are operations by a common player.

In the sixteenth invention, the player who exists in the past is the player himself in the past.

According to the sixteenth invention, a player can play a game with the player himself in the past. Also, the player can advance a current game so as to advantageously make a game play in the future, capable of heighten a strategic characteristic of this game.

A game program according to a seventeenth invention is dependent on the fifteenth or sixteenth invention, and the program causes the computer to further execute a recording step for recording the real-time operation data as the replay operation data.

In the seventeenth invention, the real-time operation data is recorded as replay operation data by a recording step (S43). The recorded replay operation data is utilized when game processing will be executed in the future.

A game program according to an eighteenth invention is dependent on the seventeenth invention, wherein the processing apparatus transmits the replay operation data recorded by the recording step to other processing apparatus via a communication means, and receives other replay operation data from the other processing apparatus via the communication means.

In the eighteenth invention, the replay operation data is transmitted and received between the processing apparatuses via the communication means (50, 136, 120). Thus, it is possible to easily realize various game plays with players.

A game program according to a nineteenth invention is dependent on any one of the eleventh to eighteenth inventions, and the first game processing and the second game processing are processing according to different game rules.

In the nineteenth invention, games different from each other are executed in parallel.

A game program according to a twentieth invention is dependent on any one of the eleventh to eighteenth inventions, wherein the first game processing and the second game processing are according to a common game rule.

In the twentieth invention, a common game is executed in parallel.

A game program according to the twenty-first invention is dependent on the eleventh invention, wherein the first area and the second area respectively correspond to a first screen (28A) and a second screen (28B).

In the twenty-first invention, two game results are respectively displayed on the two screens.

A game apparatus (12, 12A) according to a twenty-second invention is a game apparatus capable of executing a plurality of game processing in parallel, comprising a first processing means (S7) for executing first game processing as one of the plurality of game processing on the basis of first operation data and displaying a execution result at a first area (W1), a second processing means (S9) for executing second game processing as another one of the plurality of game processing on the basis of second operation data and displaying an execution result at a second area (W2), an affecting means (S13) for exerting an influence on the basis of the execution result of the first game processing by the first processing means on the second area at which the execution result of the second game processing by the second processing means is displayed.

A controlling method according to a twenty-third invention is a controlling method of a game apparatus (12, 12A) capable of executing a plurality of game processing in parallel, and comprising a first processing step (S7) for executing first game processing as one of the plurality of game processing on the basis of first operation data, and displaying a execution result at a first area (W1), a second processing step (S9) for executing second game processing as another one of the plurality of game processing on the basis of second operation data and displaying an execution result at a second area (W2), and an affecting step (S13) for exerting an influence on the basis of the execution result of the first game processing by the first processing step on the second area at which the execution result of the second game processing by the second processing step is displayed.

In each of the twenty-second and a twenty-third invention, similar to the eleventh invention, an influence of any one of the plurality of game processing can be exerted on another one of the game processing.

According to the present invention, it is possible to exert an influence among the plurality of game processing which are simultaneously executed. Furthermore, the player can play a game with the player himself in the past when there is no player with whom the player plays.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an appearance view showing a game system of one embodiment of the present invention;

FIG. 2 is a block diagram showing one example of an electric configuration of the game system;

FIG. 3 (A) is a perspective view of a controller used in the game system as seeing it from above rear;

FIG. 3 (B) is a perspective view of the controller used in the game system as seeing it from below front;

FIG. 4 is a block diagram showing one example of an electric configuration of the controller;

FIG. 5 is an illustrative view showing a state in which a game is played by means of the controller;

FIG. 6 is an illustrative view showing viewing angles of markers and the controller in the game system;

FIG. 7 is an illustrative view showing one example of an imaged image including images of the markers (object image);

FIG. 8 is a block diagram showing one example of a communication system cooperating with the game system;

FIG. 9 is an illustrative view showing one example of a game screen;

FIG. 10 is an illustrative view showing another example of a game screen;

FIG. 11(A)-FIG. 11(C) are illustrative views showing one example of a change of a first game image included in the game screen;

FIG. 12(A)-FIG. 12(C) are illustrative views showing one example of a change of a second game image included in the game screen;

FIG. 13(A)-FIG. 13(C) are illustrative views showing one example of a change of a third game image included in the game screen;

FIG. 14(A)-FIG. 14(C) are illustrative views showing a state in which the first game is affected by the second game;

FIG. 15(A)-FIG. 15(C) are illustrative views showing a state in which the third game is affected by the first game;

FIG. 16(A)-FIG. 16(C) are illustrative views for showing a state in which the second game is affected by the third game;

FIG. 17 is an illustrative view showing another example of the game screen;

FIG. 18 is an illustrative view showing a coordinate system applied to this embodiment;

FIG. 19 is an illustrative view showing one example of a memory map of an internal main memory;

FIG. 20 is an illustrative view showing structure of replay data;

FIG. 21 is an illustrative view showing structure of local affecting object data;

FIG. 22 is an illustrative view showing structure of world affecting object data;

FIG. 23 is a flowchart showing a part of an operation of the CPU;

FIG. 24 is a flowchart showing another part of the operation of the CPU;

FIG. 25 is a flowchart showing a still another part of the operation of the CPU;

FIG. 26 is a flowchart showing a further part of the operation of the CPU;

FIG. 27 is an appearance view showing an outline of the game apparatus of another embodiment of the present invention;

FIG. 28 is a block diagram showing one example of an electric configuration of the game apparatus shown in FIG. 27; and

FIG. 29(A)-FIG. 29(C) are illustrative views showing a state in which that the first game is subjected to another influence from the second game.

### DETAILED DESCRIPTION OF THE PREFERRED EMBODIMENTS

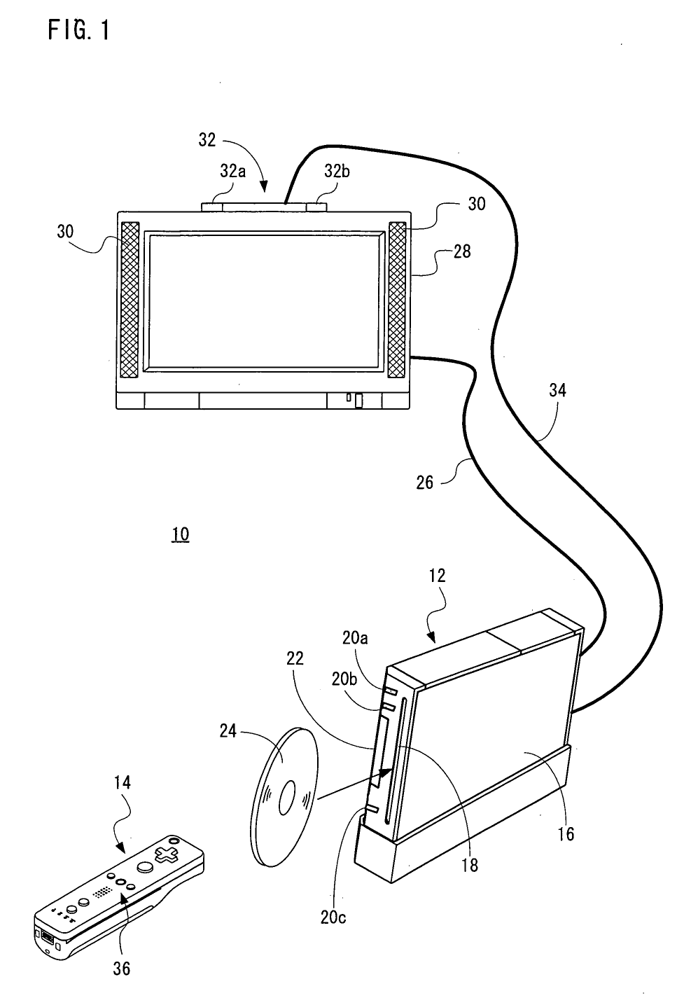

Referring to FIG. 1, a game system 10 as one embodiment of the present invention includes a game apparatus 12 and a controller 14. Although illustration is omitted, the game apparatus 12 of this embodiment is designed such that it can be connected to four controllers 14 at the maximum. Furthermore, the game apparatus 12 and the respective controllers 14 are connected by radio. The wireless communication is executed according to a Bluetooth (registered trademark) standard, for example, but may be executed by other standards such as infrared rays, a wireless LAN. In addition, it may be connected by a wire.

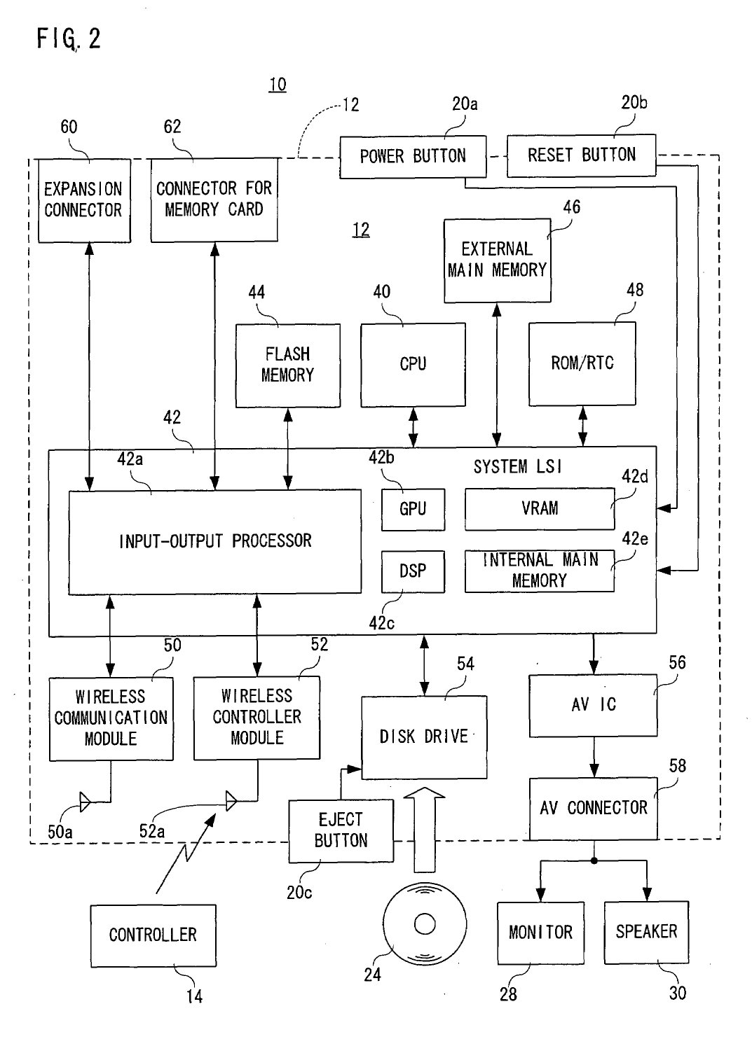

The game apparatus 12 includes a roughly rectangular parallelepiped housing 16, and the housing 16 is furnished with a disk slot 18 on a front surface. An optical disk 24 as one example of an information storage medium storing game program, etc. is inserted from the disk slot 18 to be loaded into a disk drive 54 (see FIG. 2) within the housing 16. Although illustration is omitted, around the disk slot 18, an LED and a light guide plate are arranged such that the LED of the disk slot 18 lights on or off in accordance with various processing.

Furthermore, on a front surface of the housing 16 of the game apparatus 12, a power button 20a and a reset button 20b are provided at the upper part thereof, and an eject button 20c is provided below them. In addition, a connector cover for external memory card 22 is provided between the reset button 20b and the eject button 20c, and in the vicinity of the disk slot 18. Inside the connector cover for external memory card 22, an external connector for memory card 62 (see FIG. 2) is provided, through which an external memory card (hereinafter simply referred to as a “memory card”) not shown is inserted. The memory card is employed for loading the game program, etc. read from the optical disk 24 to temporarily store it, storing (saving) game data (result data or proceeding data of the game) of the game played by means of the game system 10, and so forth. It should be noted that storing the game data described above may be performed on an internal memory, such as a flash memory 44 (see FIG. 2) inside the game apparatus 12 in place of the memory card. Also, the memory card may be utilized as a backup memory of the internal memory. In addition, in the game apparatus 12, other application except for the game may be executed, and in such a case, data of the other application can be stored in the memory card.

It should be noted that a general-purpose SD card can be employed as a memory card, but other general-purpose memory cards, such as memory sticks, multimedia cards (registered trademark) can be employed.

Although omitted in FIG. 1, the game apparatus 12 has an AV cable connector 58 (FIG. 2) on the rear surface of the housing 16, and by utilizing the AV cable connector 58, a monitor 28 and a speaker 30 are connected to the game apparatus 12 through an AV cable 26. The monitor 28 and the speaker 30 are typically a color television receiver, and through the AV cable 26, a video signal from the game apparatus 12 is input to a video input terminal of the color television, and a sound signal from the game apparatus 12 is input to a sound input terminal. Accordingly, a three-dimensional game image of a three-dimensional (3D) video game, for example, is displayed on the screen of the color television (monitor) 28, and stereo game sound, such as a game music, a sound effect, etc. is output from right and left speakers 30. Around the monitor 28 (on the top side of the monitor 28, in this embodiment), a marker unit 32 including two infrared ray LEDs (markers) 32a and 32b is provided. The marker unit 32 is connected to the game apparatus 12 through a power source cable 34. Accordingly, the marker unit 32 is supplied with power from the game apparatus 12. Thus, the markers 32a and 32b emit lights in front of the monitor 28.

Furthermore, the power of the game apparatus 12 is applied by means of a general AC adapter (not illustrated). The AC adapter is inserted into a standard wall socket for home use, and the game apparatus 12 transforms the house current (commercial power supply) to a low DC voltage signal suitable for driving. In another embodiment, a battery may be utilized as a power supply.

In the game system 10, a user or a player turns the power of the game apparatus 12 on for playing the game (or applications other than the game). Then, the user selects an appropriate optical disk 24 storing a program of a video game (or other applications the player wants to play), and loads the optical disk 24 into the disk drive 54 of the game apparatus 12. In response thereto, the game apparatus 12 starts to execute a video game or other applications on the basis of the program recorded in the optical disk 24. The user operates the controller 14 in order to apply an input to the game apparatus 12. For example, by operating any one of the operating buttons of the input means 36 including operating buttons, etc., a game or other application is started. Besides the operation on the input means 36, by moving the controller 14 itself, it is possible to move a moving image object (player object) in different directions or change the perspective of the user (camera position) in a 3-dimensional game world.

It should be noted that programs of video games and other applications are stored (installed) in an internal memory (flash memory 44 (see FIG. 2)) of the game apparatus 12, and executed from the internal memory. In such a case, a program stored in a storage medium like an optical disk 24, or the like may be installed onto the internal memory, and the downloaded program may be installed onto the internal memory.

FIG. 2 is a block diagram showing an electric configuration of the game system 10 in FIG. 1 embodiment. Although illustration is omitted, respective components within the housing 16 are mounted on a printed board. As shown in FIG. 2, the game apparatus 12 has a CPU 40 functioning as a game processor. The CPU 40 is connected with a system LSI 42. The system LSI 42 is connected with an external main memory 46, a ROM/RTC 48, a disk drive 54, and an AV IC 56.

The external main memory 46 is utilized as a work area and a buffer area of the CPU 40 by storing programs like a game program, etc. and various data. The ROM/RTC 48, which is a so-called boot ROM, is incorporated with a program for activating the game apparatus 12, and is provided with a time circuit for counting a time. The disk drive 54 reads a program, texture data, etc. from the optical disk 24, and writes them in an internal main memory 42e described later or the external main memory 46 under the control of the CPU 40.

The system LSI 42 is provided with an input-output processor 42a, a GPU (Graphics Processor Unit) 42b, a DSP (Digital Signal Processor) 42c, a VRAM 42d and an internal main memory 42e, and these are connected with one another by internal buses although illustration is omitted.

The input-output processor (I/O processor) 42a executes transmitting and receiving data and executes downloading of the data.

The GPU 42b is made up of a part of a rendering means, and receives a graphics command (construction command) from the CPU 40 to generate game image data according to the command. Additionally, the CPU 40 applies an image generating program required for generating game image data to the GPU 42b in addition to the graphics command.

Although illustration is omitted, the GPU 42b is connected with the VRAM 42d as described above. The GPU 42b accesses the VRAM 42d to acquire data (image data: data such as polygon data, texture data, etc.) required to execute the construction instruction. Additionally, the CPU 40 writes image data required for drawing to the VRAM 42d via the GPU 42b. The GPU 42b accesses the VRAM 42d to create game image data for drawing.

In this embodiment, a case that the GPU 42b generates game image data is explained, but in a case of executing an arbitrary application except for the game application, the GPU 42b generates image data as to the arbitrary application.

Furthermore, the DSP 42c functions as an audio processor, and generates audio data corresponding to a sound, a voice, music, or the like to be output from the speaker 30 by means of the sound data and the sound wave (tone) data stored in the internal main memory 42e and the external main memory 46.

The game image data and audio data generated as described above are read by the AV IC 56, and output to the monitor 28 and the speaker 30 via the AV connector 58. Accordingly, a game screen is displayed on the monitor 28, and a sound (music) necessary for the game is output from the speaker 30.

Furthermore, the input-output processor 42a is connected with an expansion connector 60 and a connector for memory card 62 as well as a flash memory 44, a wireless communication module 50 and a wireless controller module 52. The wireless communication module 50 is connected with an antenna 50a, and the wireless controller module 52 is connected with an antenna 52a.

The input-output processor 42a can communicate with other game apparatuses and various servers to be connected to a network (not shown) via a wireless communication module 50. It should be noted that it is possible to directly communicate with another game apparatus without going through the network. The input-output processor 42a periodically accesses the flash memory 44 to detect the presence or absence of data (referred to as data to be transmitted) being required to be transmitted to a network, and transmits it to the network via the wireless communication module 50 and the antenna 50a in a case that data to be transmitted is present. Furthermore, the input-output processor 42a receives data (referred to as received data) transmitted from another game apparatuses via the network, the antenna 50a and the wireless communication module 50, and stores the received data in the flash memory 44. If the received data does not satisfy a predetermined condition, the reception data is abandoned as it is. In addition, the input-output processor 42a can receive data (download data) downloaded from the download server (not shown) via the network, the antenna 50a and the wireless communication module 50, and store the download data in the flash memory 44.

Furthermore, the input-output processor 42a receives input data transmitted from the controller 14 via the antenna 52a and the wireless controller module 52, and (temporarily) stores it in the buffer area of the internal main memory 42e or the external main memory 46. The input data is erased from the buffer area after being utilized in processing by the CPU 40 (game processing, for example).

In this embodiment, as described above, the wireless controller module 52 makes communications with the controller 14 in accordance with Bluetooth standards.

In addition, the input-output processor 42a is connected with the expansion connector 60 and the connector for memory card 62. The expansion connector 60 is a connector for interfaces, such as USB, SCSI, etc., and can be connected with medium such as an external storage, and peripheral devices such as another controller other than the controller 14. Furthermore, the expansion connector 60 is connected with a cable LAN adaptor, and can utilize the cable LAN in place of the wireless communication module 50. The connector for memory card 62 can be connected with an external storage like a memory card. Thus, the input-output processor 42a, for example, accesses the external storage via the expansion connector 60 and the connector for memory card 62 to store and read the data.

Although a detailed description is omitted, as shown in FIG. 1, the game apparatus 12 (housing 16) is furnished with the power button 20a, the reset button 20b, and the eject button 20c. The power button 20a is connected to the system LSI 42. When the power button 20a is turned on, the system LSI 42 is set in a mode of a normal energized state (referred to as “normal mode”) in which the respective components of the game apparatus 12 are supplied with power through an AC adapter not shown. On the other hand, when the power button 20a is turned off, the system LSI 42 is set to a mode in which a part of the components of the game apparatus 12 is supplied with power, and the power consumption is reduced to minimum (hereinafter referred to as “standby mode”).

In this embodiment, in a case that the standby mode is set, the system LSI 42 issues an instruction to stop supplying the power to the components except for the input-output processor 42a, the flash memory 44, the external main memory 46, the ROM/RTC 48 and the wireless communication module 50, and the wireless controller module 52. Accordingly, in this embodiment, the CPU 40 never executes an application in the stand-by mode.

Although the system LSI 42 is supplied with power even in the standby mode, supply of clocks to the GPU 42b, the DSP 42c and the VRAM 42d are stopped so as not to be driven, realizing reduction in power consumption.

Although illustration is omitted, inside the controller 16 of the game apparatus 12, a fan is provided for excluding heat of the IC, such as the CPU 40, the system LSI 42, etc. to outside. In the standby mode, the fan is also stopped.

However, in a case that the standby mode is not desired to be utilized, when the power button 20a is turned off, by making the standby mode unusable, the power supply to all the circuit components are completely stopped.

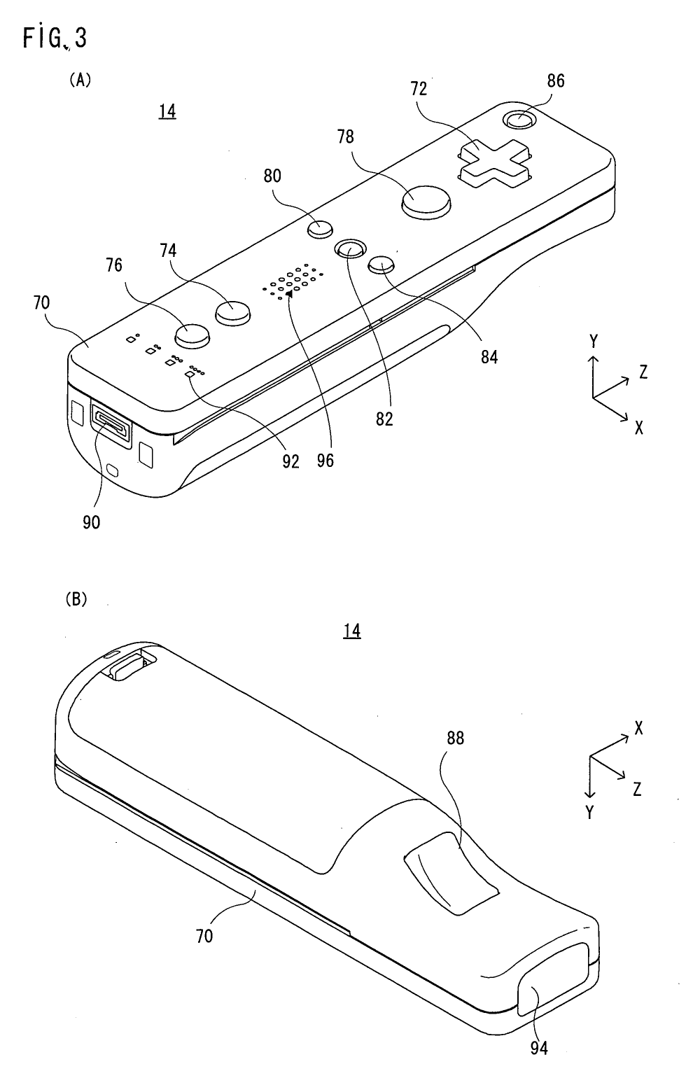

Furthermore, switching between the normal mode and the standby mode can be performed by turning on and off the power switch 86 (FIG. 3) of the controller 14 by remote control. If the remote control is not performed, setting is made such that the power supply to the wireless controller module 52a is not performed in the standby mode.

The reset button 20b is also connected with the system LSI 42. When the reset button 20b is pushed, the system LSI 42 restarts the activation program of the game apparatus 12. The eject button 20c is connected to the disk drive 54. When the eject button 20c is pushed, the optical disk 24 is removed from the disk drive 54.

Each of FIG. 3 (A) to FIG. 3 (B) shows one example of an external appearance of the controller 14. FIG. 3 (A) is a perspective view showing a front end surface, a top surface and a right side surface of the controller 14, and FIG. 3 (B) is a perspective view showing a back end surface, a lower surface and a left side surface of the controller 14.

Referring to FIG. 3 (A) and FIG. 3 (B), the controller 14 has a housing 70 formed by plastic molding, for example. The housing 70 is formed into an approximately rectangular parallelepiped shape and has a size small enough to be held by one hand of a user. The housing 70 (controller 14) is provided with the input means (a plurality of buttons or switches) 36 as described above. Specifically, as shown in FIG. 3 (A), on an upper face of the housing 70, there are provided a cross key 72, a 1 button 74, a 2 button 76, an A button 78, a − (minus) button 80, a HOME button 80, a + (plus) button 84 and a power switch 86. Moreover, as shown in FIG. 3 (B) an inclined surface is formed on a lower surface of the housing 70, and a B-trigger switch 88 is formed on the inclined surface.

The cross key 72 is a four directional push switch, including four directions of front (or upper), back (or lower), right and left operation parts. By operating any one of the operation parts, it is possible to instruct a moving direction of a character or object (player character or player object) that is operable by a player or instruct a moving direction of a cursor.

The 1 button 74 and the 2 button 76 are respectively push button switches, and are used for a game operation such as adjusting a viewpoint position and a viewpoint direction on displaying the 3D game image, i.e. a position and an image angle of a virtual camera. Alternatively, the 1 button 74 and the 2 button 76 can be used for an operation the same as that of the A button 78 and the B-trigger switch 88 or an auxiliary operation.

The A-button switch 78 is the push button switch, and is used for causing the player character or the player object to take an action other than a direction instruction, specifically arbitrary actions such as hitting (punching), throwing, grasping (acquiring), riding, and jumping, etc. For example, in an action game, it is possible to give an instruction to jump, punch, move a weapon, and so forth. Also, in a roll playing game (RPG) and a simulation RPG, it is possible to instruct to acquire an item, select and determine the weapon and command, and so forth. Furthermore, the A button switch 78 is used for instructing decision of an icon or a button image pointed by the pointer (instruction image) on the game screen. For example, when the icon and the button image are decided, an instruction or a command (command of the game) set in advance corresponding thereto can be input.

The − button 80, the HOME button 82, the + button 84, and the power supply switch 86 are also push button switches. The − button 80 is used for selecting a game mode. The HOME button 82 is used for displaying a game menu (menu screen). The + button 84 is used for starting (re-starting) or pausing a game. The power supply switch 86 is used for turning on and off a power supply of the game apparatus 12 by remote control.

In this embodiment, note that the power supply switch for turning on/off the controller 14 itself is not provided, and the controller 14 is set at on-state by operating any one of the switches or buttons of the input means 36 of the controller 14, and when not operated for a certain period of time (30 seconds, for example) or more, the controller 14 is automatically set to an off-state.

The B-trigger switch 88 is also the push button switch, and is mainly used for making an input like a trigger such as shooting, and designating a position selected by the controller 14. In a case that the B-trigger switch 88 is continued to be pushed, it is possible to make movements and parameters of the player object constant. In a fixed case, the B-trigger switch 88 functions in the same way as a normal B-button, and is used for canceling an action or a command determined by the A button 78.

As shown in FIG. 3 (A), an external expansion connector 90 is provided on a back end surface of the housing 70, and as shown in FIG. 3 (B), an indicator 92 is provided on the top surface and the side of the back end surface of the housing 70. The external expansion connector 90 is utilized for connecting another expansion controller not shown different from the controller 14. The indicator 92 is made up of four LEDs, for example, and shows identification information (controller number) of the controller 14 by lighting any one of the four LEDs and depending on the lighted LED, and the indicator 92 shows the remaining amount of power of the controller 14 depending on the number of LEDs to be lit up.

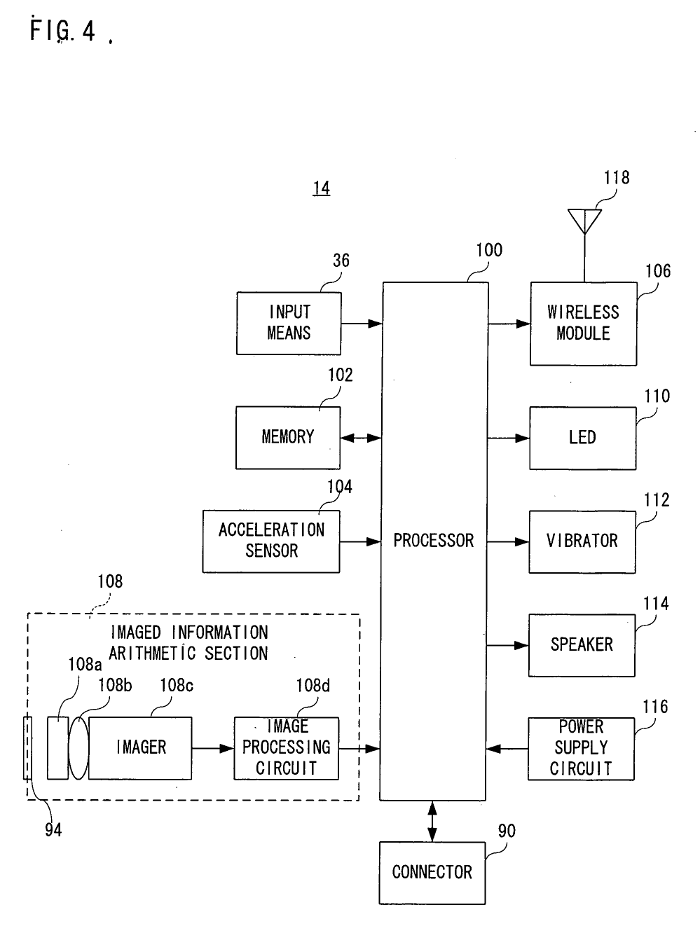

In addition, the controller 14 has an imaged information arithmetic section 108 (see FIG. 4), and as shown in FIG. 3 (B), a light incident opening 94 of the imaged information arithmetic section 108 is provided on the front end surface of the housing 70. Furthermore, the controller 14 has a speaker 114 (see FIG. 4), and the speaker 114 is provided inside the housing 70 at the position corresponding to a sound release hole 96 between the 1 button 74 and the HOME button 82 on the tope surface of the housing 70 as shown in FIG. 3 (A).

Note that as shown in FIG. 3 (A) to FIG. 3 (B), the shape of the controller 14 and the shape, number and setting position of each input means 36 are simply examples, and they may be modified as necessary.

FIG. 4 is a block diagram showing an electric configuration of the controller 14. Referring to FIG. 4, the controller 14 includes a processor 100, and the processor 100 is connected with the external expansion connector 90, the input means 36, a memory 102, an acceleration sensor 104, a wireless module 106, the imaged information arithmetic section 108, an LED 110 (the indicator 92), an vibrator 112, a speaker 114, and a power supply circuit 116 by an internal bus (not shown). Moreover, an antenna 118 is connected to the wireless module 106.

It should be noted that although omitted in FIG. 4, the indicator 92 is made up of four LEDs 110 as described above.

The processor 100 is in charge of an overall control of the controller 14, and transmits (inputs) information (input information) input by the input means 36, the acceleration sensor 104, and the imaged information arithmetic section 108 as input data to the game apparatus 12 via the wireless module 106 and the antenna 118. At this time, the processor 100 uses the memory 102 as a working area or a buffer area. An operation signal (operation data) from the aforementioned input means 36 (72-84) is input to the processor 100, and the processor 100 stores the operation data once in the memory 102.

Moreover, as shown in FIG. 3, the acceleration sensor 104 detects each acceleration of the controller 14 in directions of three axes of vertical direction (y-axial direction), lateral direction (x-axial direction), and forward and rearward directions (z-axial direction). The acceleration sensor 104 is typically an acceleration sensor of an electrostatic capacity type, but the acceleration sensor of other type may also be used.

For example, the acceleration sensor 104 detects the accelerations (ax, ay, and az) in each direction of x-axis, y-axis, z-axis for each first predetermined time, and inputs the data of the acceleration (acceleration data) thus detected to the processor 100. For example, the acceleration sensor 104 detects the acceleration in each direction of the axes in a range from −2.0 G to 2.0 G (G indicates a gravitational acceleration. The same thing can be the hereafter.) The processor 100 detects the acceleration data given from the acceleration sensor 104 for each second predetermined time, and stores it in the memory 102 once.

The processor 100 creates input data including at least one of the operation data, acceleration data and marker coordinate data as described later, and transmits the input data thus created to the game apparatus 12 for each third predetermined time (5 msec, for example).

In this embodiment, although omitted in FIG. 3, the acceleration sensor 104 is provided inside the housing 70 and in the vicinity on the circuit board where the cross key 72 is arranged.

It will be appreciated by those skilled in the art from the description of this specification that a computer, such as a processor (CPU 40, for example) of the game apparatus 12 or the processor (processor 100, for example) of the controller 14 executes processing on the basis of an acceleration signal output from the acceleration sensors 104, and whereby, more information relating to the controller 14 can be estimated or calculated (determined).

The controller is incorporated with the single axis acceleration sensor 104, for example, and in a case that processing is executed on the side of the computer assuming that the controller 14 is in a static state, that is, processing is executed considering that accelerations detected by the acceleration sensor 104 is only gravitational accelerations, if the controller 14 is actually in a static state, it is possible to know whether or not the orientations of the controller 14 is inclined with respect to the direction of gravity or to what extent they are inclined on the basis of the detected acceleration. More specifically, when a state in which the detection axis of the acceleration sensor 104 is directed to a vertically downward direction is taken as a reference, merely whether or not 1G (gravitational acceleration) is imposed on can show whether or not the controller 14 is inclined, and the size can show to what extent it is inclined.

Furthermore, if a multi-axes acceleration sensor 104 is mounted on the controller 14, by further performing processing on an acceleration signal of each axis, it is possible to more precisely know to what extent the controller 14 is inclined with respect to the direction of gravity. In this case, on the basis of outputs from the acceleration sensor 104, the processor 100 may perform processing of calculating data of inclined angle of the controller 14, but perform processing of estimating an approximate inclination on the basis of the outputs from the acceleration sensor 104 without performing the processing of calculating the data of the inclined angle. Thus, by using the acceleration sensor 104 in conjunction with the processor 100, it is possible to determine an inclination, an orientation or a position of the controller 14.

On the other hand, assuming that the acceleration sensor 104 are in a dynamic state, accelerations according to the movement of the acceleration sensor 104 is detected in addition to the gravitational acceleration component, and therefore, if the gravitational acceleration component is removed by predetermined processing, it is possible to know a moving direction, etc. More specifically, in a case that the controller 14 being furnished with the acceleration sensor 104 is accelerated and moved by the hand of the user, acceleration data generated by the acceleration sensor 104 is processed, and whereby, it is possible to calculate various movements and/or positions of the controller 14.

Additionally, even when assuming that the acceleration sensor 104 is in a dynamic state, if an acceleration in correspondence with the movement of the acceleration sensor 104 is removed by the predetermined processing, it is possible to know the inclination with respect to the direction of gravity. In another embodiment, the acceleration sensor 104 may contain a built-in signal processing apparatus or other kinds of dedicated processing apparatuses for performing desired processing on the acceleration signal (acceleration data) output from the incorporated acceleration detecting means before outputting the acceleration signal to the processor 100. For example, in a case that the acceleration sensor 104 is one for detecting a static acceleration (gravitational acceleration, for example), the built-in or dedicated processing apparatuses may be one for transforming the detected acceleration data into the inclined angle (or other preferable parameters) corresponding thereto.

The wireless module 106 modulates a carrier at a predetermined frequency by the input data, by using a technique of Bluetooth, for example, and emits its weak radio wave signal from the antenna 118. Namely, the input data is modulated to the weak radio wave signal by the wireless module 106 and transmitted from the antenna 118 (controller 14). The weak radio wave signal is received by the wireless controller module 52 provided to the aforementioned game apparatus 12. The weak radio wave thus received is subjected to demodulating and decoding processing. This makes it possible for the game apparatus 12 (CPU 40) to acquire the input data from the controller 14. Then, the CPU 40 performs processing of an application (game processing), following the input data and the program (game program).

In addition, as described above, the controller 14 is provided with the imaged information arithmetic section 108. The imaged information arithmetic section 108 is made up of an infrared rays filter 108a, a lens 108b, an imager 108c, and an image processing circuit 108d. The infrared rays filter 108a passes only infrared rays from the light incident from the front of the controller 14. As described above, the markers 32a and 32b placed near (around) the display screen of the monitor 28 are infrared LEDs for outputting infrared lights forward the monitor 28. Accordingly, by providing the infrared rays filter 108a, it is possible to image the image of the markers 32a and 32b more accurately. The lens 108b condenses the infrared rays passing thorough the infrared rays filter 108a to emit them to the imager 108c. The imager 108c is a solid imager, such as a CMOS sensor and a CCD, for example, and images the infrared rays condensed by the lens 108b. Accordingly, the imager 108c images only the infrared rays passing through the infrared rays filter 108a to generate image data. Hereafter, the image imaged by the imager 108c is called an “imaged image”. The image data generated by the imager 108c is processed by the image processing circuit 108d. The image processing circuit 108d calculates a position of an object to be imaged (markers 32a and 32b) within the imaged image, and outputs each coordinate value indicative of the position to the processor 100 as imaged data (marker coordinates data to be described later) for each fourth predetermined time. It should be noted that a description of the process in the image processing circuit 108d is made later.

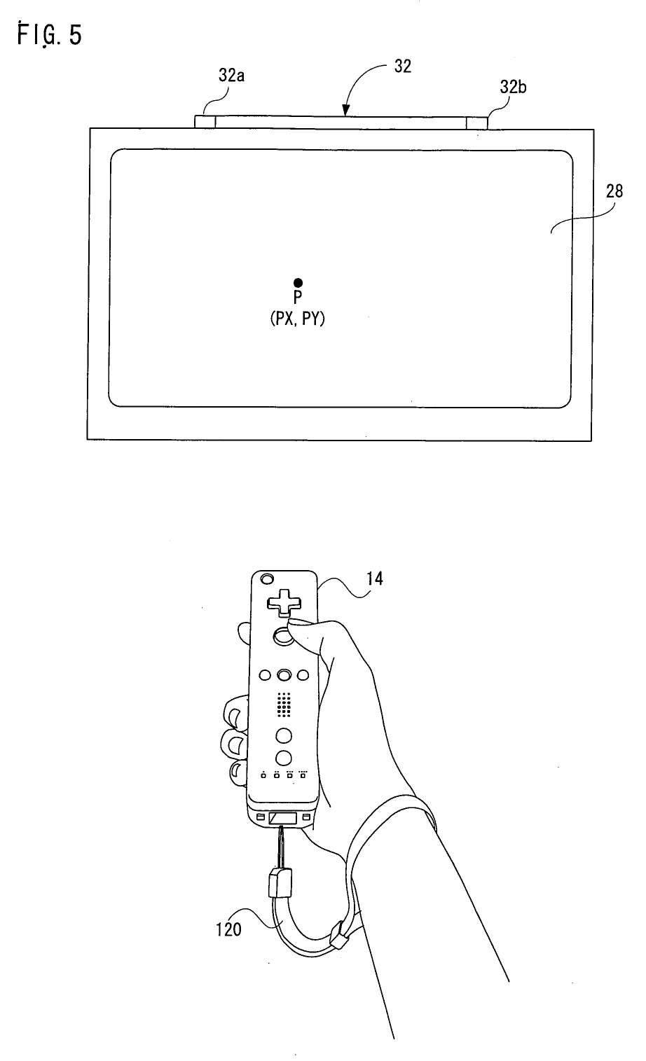

FIG. 5 is an illustrative view summarizing a state when a player plays a game by utilizing the controller 14. As shown in FIG. 5, when playing the game by means of the controller 14 in the game system 10, the player holds the controller 14 with the palm of one hand in a state that a strap 120 tied at one end of the controller 14 is wound around the wrist of the same hand. Strictly speaking, the player holds the controller 14 in a state that the front end surface (the side of the incident light opening 94 of the light imaged by the imaged information arithmetic section 108 shown in FIG. 3) of the controller 14 is oriented to the markers 32a and 32b. It should be noted that the markers 32a and 32b are placed in parallel with the horizontal direction of the screen of the monitor 28 as illustrated. In this state, the player performs a game operation by changing a position on the screen indicated by the controller 14 and changing a distance between the controller 14 and each of the markers 32a and 32b.

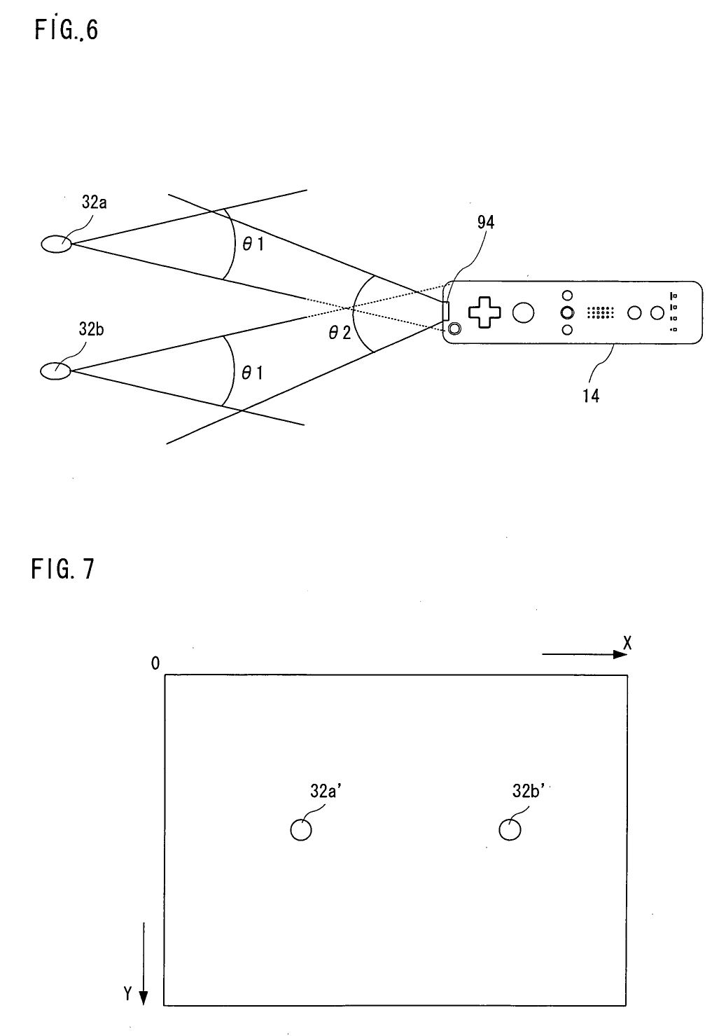

FIG. 6 is a view showing viewing angles between the respective markers 32a and 32b, and the controller 14. As shown in FIG. 6, each of the markers 32a and 32b emits infrared ray within a range of a viewing angle θ1. Also, the imager 108c of the imaged information arithmetic section 108 can receive incident light within the range of the viewing angle θ2 taking the line of sight of the controller 14 as a center. For example, the viewing angle θ1 of each of the markers 32a and 32b is 34° (half-value angle) while the viewing angle θ2 of the imager 108c is 41°. The player holds the controller 14 such that the imager 108c is directed and positioned so as to receive the infrared rays from the markers 32a and 32b. More specifically, the player holds the controller 14 such that at least one of the markers 32a and 32b exists in the viewing angle θ2 of the imager 108c, and the controller 14 exists in at least one of the viewing angles θ1 of the marker 32a or 32b. In this state, the controller 14 can detect at least one of the markers 32a and 32b. The player can perform a game operation by changing the position and the orientation of the controller 14 in the range satisfying the state.

If the position and the orientation of the controller 14 are out of the range, the game operation based on the position and the orientation of the controller 14 cannot be performed. Hereafter, the above-described range is called an “operable range.”

If the controller 14 is held within the operable range, an image of each of the markers 32a and 32b is imaged by the imaged information arithmetic section 108. That is, the imaged image obtained by the imager 108c includes an image (object image) of each of the markers 32a and 32b as an object to be imaged. FIG. 7 is a view showing one example of the imaged images including an object image. The image processing circuit 108d calculates coordinates (marker coordinates) indicative of the position of each of the markers 32a and 32b in the imaged image by utilizing the image data of the imaged image including the object images. It should be noted that the coordinates calculated here are according to a world coordinate system (X-Y coordinate system: described below) taking the upper left edge of the imaged image (game screen) as an origin point O.

Since each of the object images appears as a high-intensity part in the image data of the imaged image, the image processing circuit 108d first detects the high-intensity part as a candidate of the object image. Next, the image processing circuit 108d determines whether or not the high-intensity part is an object image on the basis of the size of the detected high-intensity part. The imaged image may include images other than the object image due to sunlight through a window and light of a fluorescent lamp in the room as well as the images 32a′ and 32b′ corresponding to the two markers 32a and 32b as an object image. The determination processing whether or not the high-intensity part is an object image is executed for discriminating the images 32a′ and 32b′ of the two markers 32a and 32b as an object image from the images other than them, and accurately detecting the object image. More specifically, in the determination process, it is determined whether or not the detected high-intensity part is within the size of the preset predetermined range. Then, if the high-intensity part is within the size of the predetermined range, it is determined that the high-intensity part represents the object image. On the contrary, if the high-intensity part is not within the size of the predetermined range, it is determined that the high-intensity part represents the images other than the object image.

In addition, as to the high-intensity part which is determined to represent the object image as a result of the above-described determination processing, the image processing circuit 108d calculates the position of the high-intensity part. More specifically, the barycenter position of the high-intensity part is calculated. Here, the coordinates of the barycenter position is called “marker coordinates”. Also, the barycenter position can be calculated with more detailed scale than the resolution of the imager 108c. Now, the resolution of the imaged image imaged by the imager 108c shall be 126×96, and the barycenter position shall be calculated with the scale of 1024×768. That is, the marker coordinates are represented by the integer from (0, 0) to (1024, 768).

Additionally, the position in the imaged image shall be represented by a coordinate system (X-Y coordinate system) taking the upper left of the imaged image as an origin point, the downward direction as an Y-axis positive direction, and the right direction as an X-axis positive direction.

Also, if each of the object images is properly detected, two high-intensity parts are determined as object images by the determination process, and therefore, two marker coordinates are calculated. The image processing circuit 108d outputs data indicative of the calculated two markers coordinates. The data of the output marker coordinates (marker coordinate data) is included in the input data by the processor 100 as described above, and transmitted to the game apparatus 12.

The game apparatus 12 (CPU 40) detects the marker coordinate data from the received input data to thereby calculate an instructed position P (instructed coordinate PX, PY) by the controller 14 on the screen of the monitor 28 and a distances from the controller 14 to each of the markers 32a and 32b on the basis of the marker coordinate data. More specifically, from the position of the mid point of the two marker coordinates, a position to which the controller 14 faces, that is, an instructed position is calculated. The distance between the object images in the imaged image is changed depending on the distance between the controller 14 and each of the markers 32a and 32b, and therefore, the game apparatus 12 can grasp the distance between the controller 14 and each of the markers 32a and 32b by calculating the distance between the two marker coordinates.

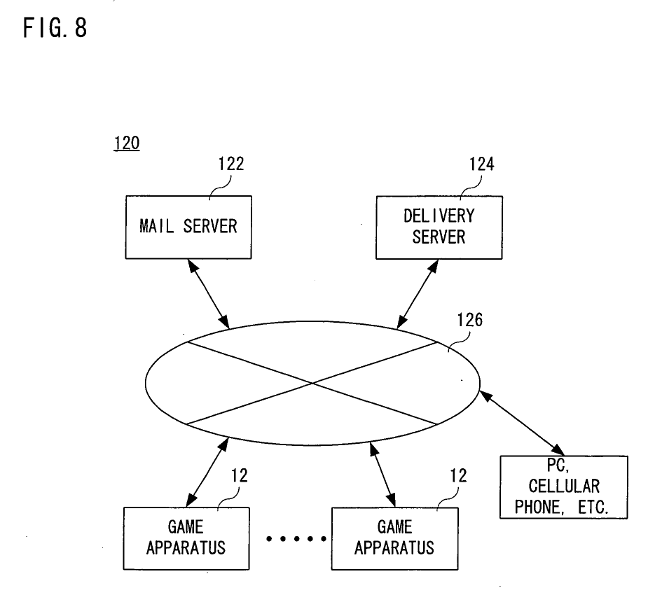

FIG. 8 is one example of a communication system 120 utilizing the game apparatus 12. As shown in FIG. 8, the communication system 120 includes a plurality of games apparatuses 12, and each of the game apparatuses 12 is connected to a mail server 122 and a delivery server 124 via a network 126 like the Internet and a LAN. By being connected to such the network 126, it becomes possible to perform transmitting and receiving of messages via the mail server 122 and download of data from the delivery server 124.

The game apparatuses 12 are capable of communicating with each other via the network 126. A message input by a player and a message generated by a game apparatus 12 are transformed into an electronic mail format so as to be transmitted and received (exchanged) between the game apparatuses 12 via the network 126 and the mail server 122. Thus, as a mail server 122, it is possible to use versatile mail servers. Also, the game apparatus 12 can transmit and receive messages, i.e., electronic mails with terminals (terminal except for other game apparatuses 12), such as a PC, a cellular phone. Furthermore, by attaching game data to an electronic mail message, it is possible to exchange game data (replay data, etc. described later) with another game apparatus 12.

Processing in a case that a plurality of games are performed (hereinafter, referred to as a parallel game) in the game system 10 which is configured as described above is described below. First, an outline of the parallel game is described. Here, three game processing is simultaneously executed, and three images respectively corresponding to the three game processing are displayed on a single game screen (28).

The three game processing may be followed by a common rule, or may be followed by different rules from each other. That is, the first to third three game processing respectively correspond to first to third games in general, but may correspond to any one or two of the three, first to third, games.

Furthermore, each of the three game processing is generally executed on the basis of a current operation by the user, but may be executed on the basis of replay data of a past operation. Accordingly, the game may simultaneously be played by two or three persons, or may be played by a single person. In a case that the game is played by a single person, each of the two other game processing is executed on the basis of a past operation, that is, replay data of the past operation of the player himself or of a past operation of other person. Furthermore, only one out of the two other game processing may be executed on the basis of replay data, and the other is never executed.

FIG. 9 shows one example of a game screen when three games are played by three persons. On the game screen shown in FIG. 9, three games (first to third games) advances on the basis of current operations (real-time playing data) of three persons (players 1 to 3).

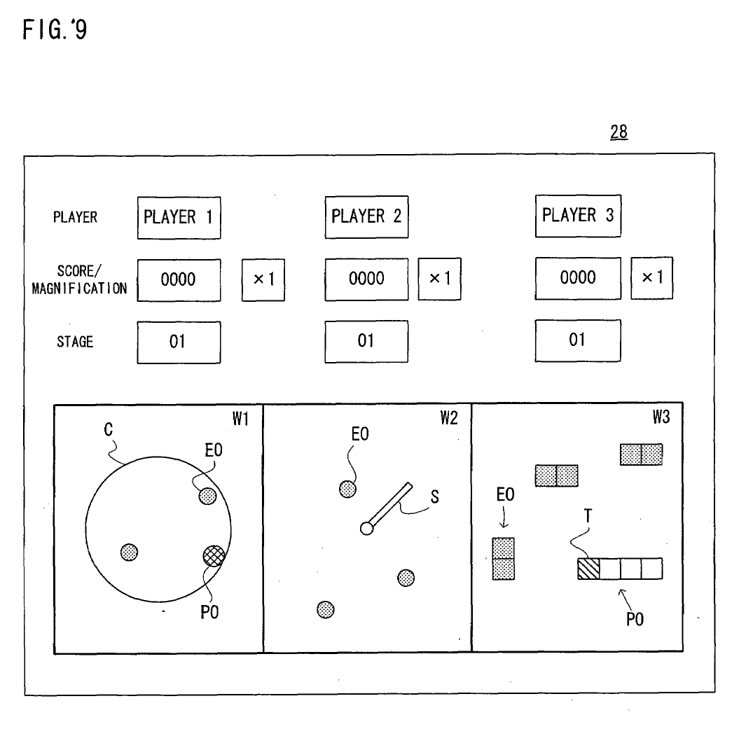

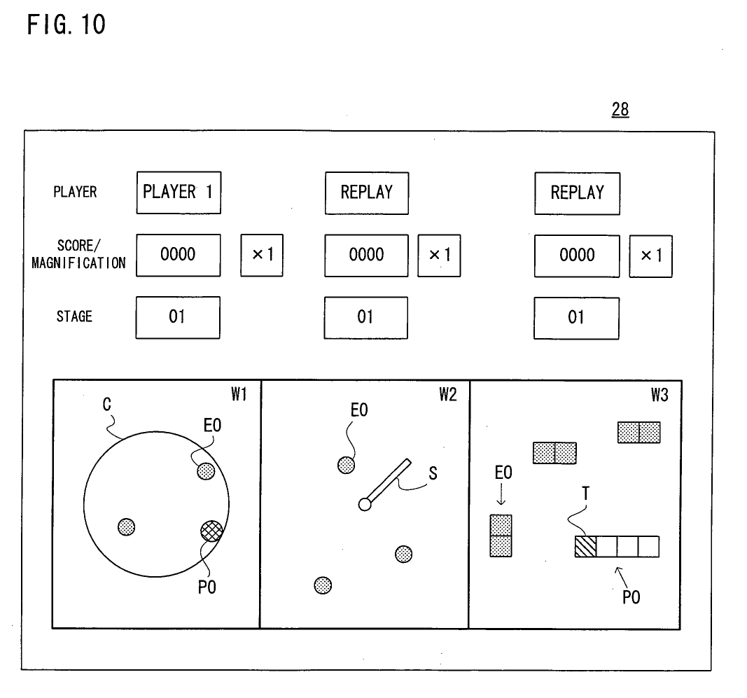

FIG. 10 shows one example of the game screen when the three games are played by a single person. On the game screen shown in FIG. 10, only the first game (W1) advances on the basis of a current operation by the player 1, and the second and third games advance on the basis of past operations (replay data). Here, the past operation shall be operations by the player 1 himself or herself. Thus, the player 1 plays with him himself in the past.

Referring to FIG. 9 or FIG. 10, the game screen includes three windows W1-W3. Here, an image of the first game is displayed on the window W1, an image of the second game is displayed on the window W2, and an image of the third game is displayed on the window W3. In addition, the players 1-3 are respectively assigned to the windows W1-W3. Thus, the first game advances on the basis of a current operation by the player 1, the second game advances on the basis of a current operation by the player 2, and the third game advances on the basis of a current operation by the player 3.

On the game screen, a numerical value indicating a progress of the game processing, specifically, three numerical values indicating a score, a magnification and a stage are displayed for each window (that is, for each game processing). The three numerical values assigned to each of the windows are updated in correspondence to the advance of the game processing.

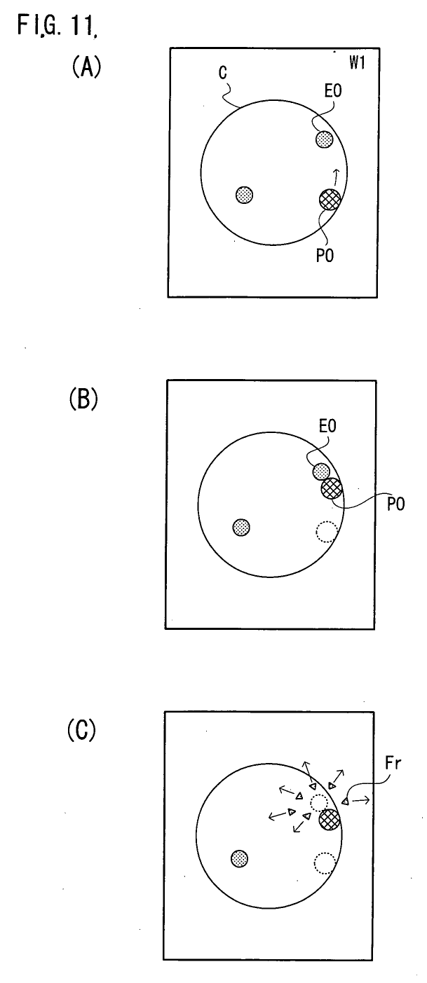

An example of advancement of the first game is shown in FIG. 11(A)-FIG. 11(C). Referring to FIG. 11(A), the game image includes a circle C, a player object PO moving along the circle C, and an enemy object EO moving in an arbitrary direction across the circle C. The movement of the player object PO is based on operation data (real-time data) from the controller 14 or replay data stored in the flash memory 44, etc. For example, in response to an operation of the A button 78, the player object PO inverts its moving direction, and acts such as jumping, etc. When the player object PO hits the enemy object EO (see FIG. 11(B)), the enemy object EO explodes, and the fragments Fr thereof fly off (see FIG. 11(C)). The score, magnification and stage are calculated on the basis of the number of enemy objects thus exploded.

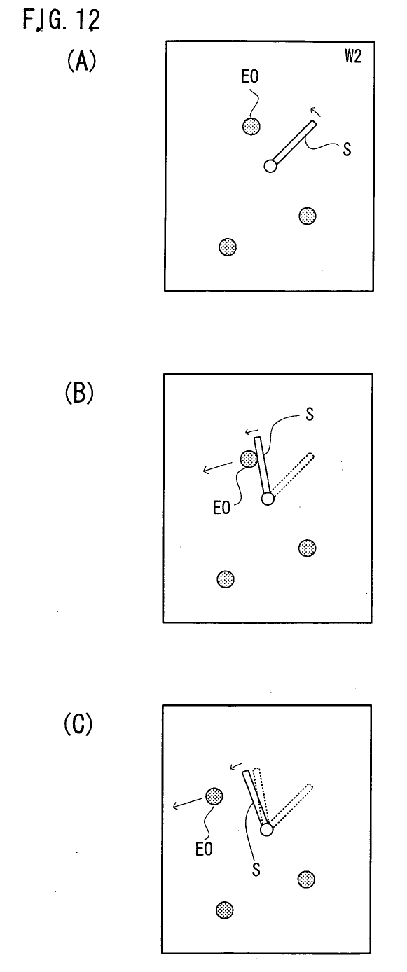

An example of advancement of the second game is shown in FIG. 12(A) to FIG. 12(C). Referring to FIG. 12(A), the game image includes a stick S rotating about one end thereof, and an enemy object EO moving in an arbitrary direction around the stick S. The movement of the stick S is controlled on the basis of real-time data or replay data like above description. With respect to an operation of the A button 78, the movement of the stick S is switched between a position fixed state while the operation is made, and a movement allowable state when the operation is cancelled. In the position fixed state, the stick S rotates at that position, and in the movement allowable state, the stick S moves while rotating by the processing on the basis of a centrifugal force of the rotation and inertia. When the stick S hits the enemy object EO (see FIG. 12(B)), the enemy object EO is flipped in a direction vertical to the stick S (see FIG. 12(C)). The score, magnification and stage are calculated on the basis of the number of enemy objects thus flipped.

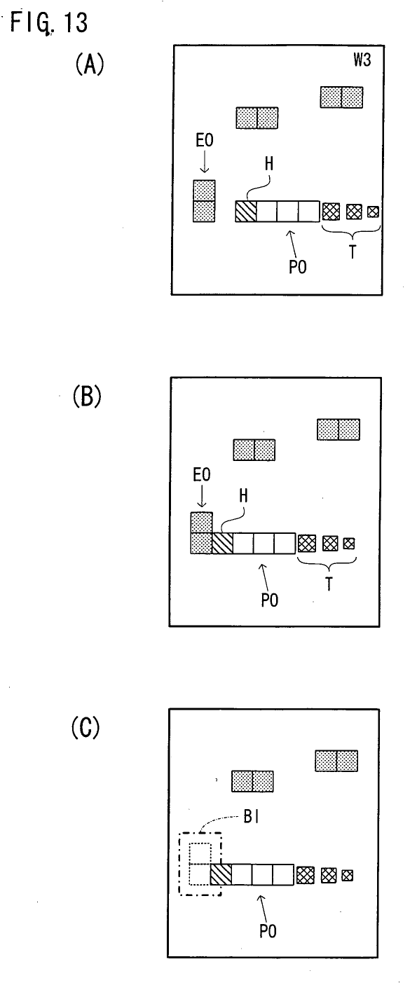

An example of advancement of the third game is shown in FIG. 13(A)-FIG. 13(C). Referring to FIG. 13(A), the game image includes a player object PO having a head H and a tail T and an enemy object EO arranged around the player object PO. A direction of the player object PO, that is, a position of the head H is changed on the basis of real-time data or replay data as described above. More specifically, the head H changes the position in response to an operation of the cross key. When the head H is closely contact with the enemy object EO (see FIG. 13(B)), the enemy object EO bursts into flames to thereby cause a blast B1 (see FIG. 13(C)). The score, magnification and stage are calculated on the basis of the number of enemy objects thus burnt.

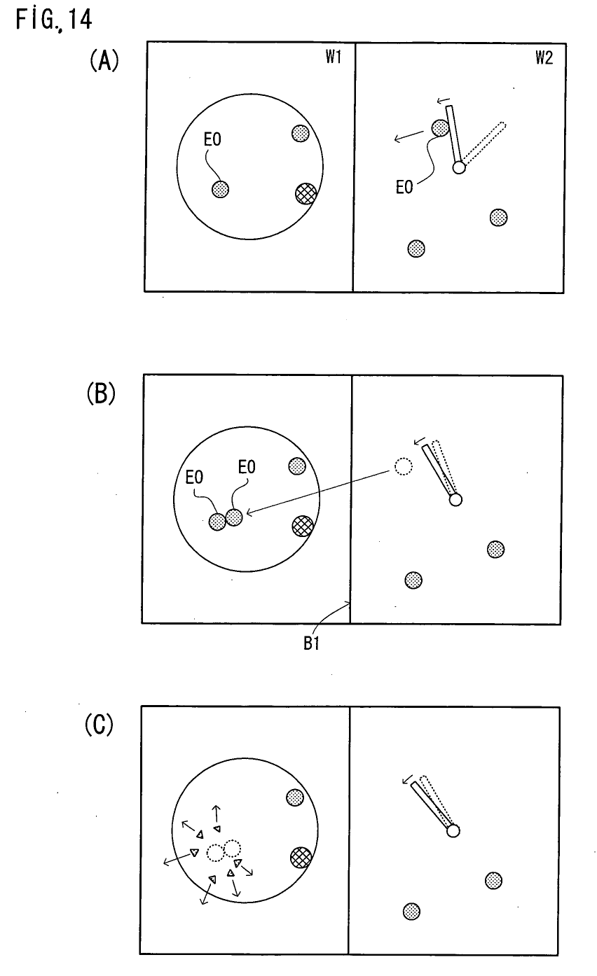

When such first to third games advances in parallel, one game is affected by another game. FIG. 14(A)-FIG. 14(C) show one example of an influence exerted among the games. Referring to FIG. 14(A) and FIG. 14(B), the enemy object EO flipped within the second game enters the first game across a boarder B1 between the windows W2 and W1. Referring to FIG. 14(C), within the first game screen, another enemy object EO exists in the path of the enemy object EO to come into collision between both of the enemy objects EO and cause an explosion.

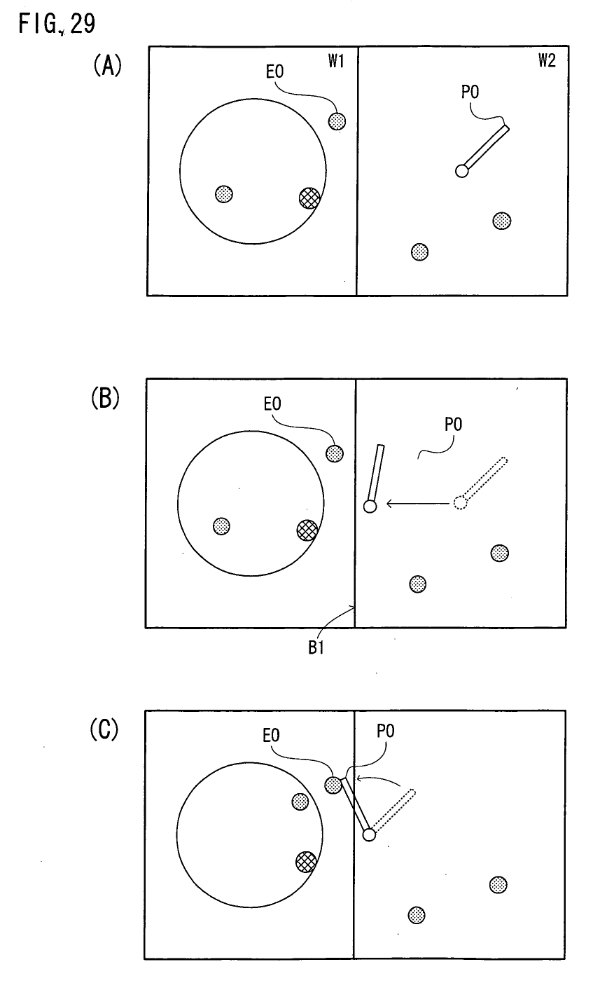

FIG. 29(A)-FIG. 29(C) show another example of an influence exerted among the games. Referring to FIG. 29(A), a player object PO within the window W2 moves to the side of the window W1 by its own rotation while the A button is released. On the other hand, within the window W1, an enemy object EO exists in the vicinity of the boarder B1 with the window W2. Referring to FIG. 29(B), the player pushes the A button at a timing when the player object PO comes to a proper position with respect to this enemy object EO. In response thereto, the stick S continues to rotate about one end thereof, and hits the enemy object EO within the window W1 at the other end thereof across the boarder B1 as shown in FIG. 29(C).

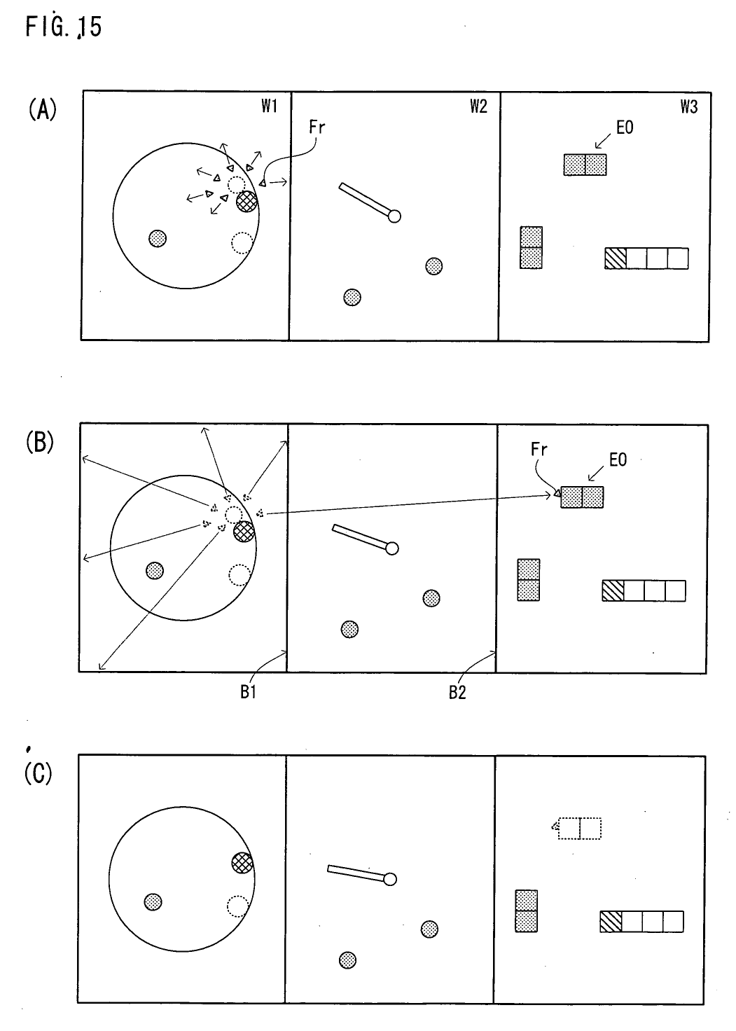

FIG. 15(A)-FIG. 15(C) show a still another example of an influence exerted among the games. Referring to FIG. 15(A) and FIG. 15(B), one of the fragments Fr flying due to an explosion within the first game first enters the second game screen across the boarder B1 between the windows W1 and W2. No object exists within the second game in the path of the fragment Fr which comes across the boarder. Thus, the fragment Fr passes straight through the second screen, and then enters into the third game screen across the boarder B2 between the windows W2 and W3. Within the third game screen, an enemy object EO exists in the path of the fragment Fr, and the enemy object EO explodes due to a hit with the fragment Fr. Thus, the influence exerts between the first game and the third game which are separated by the second game.

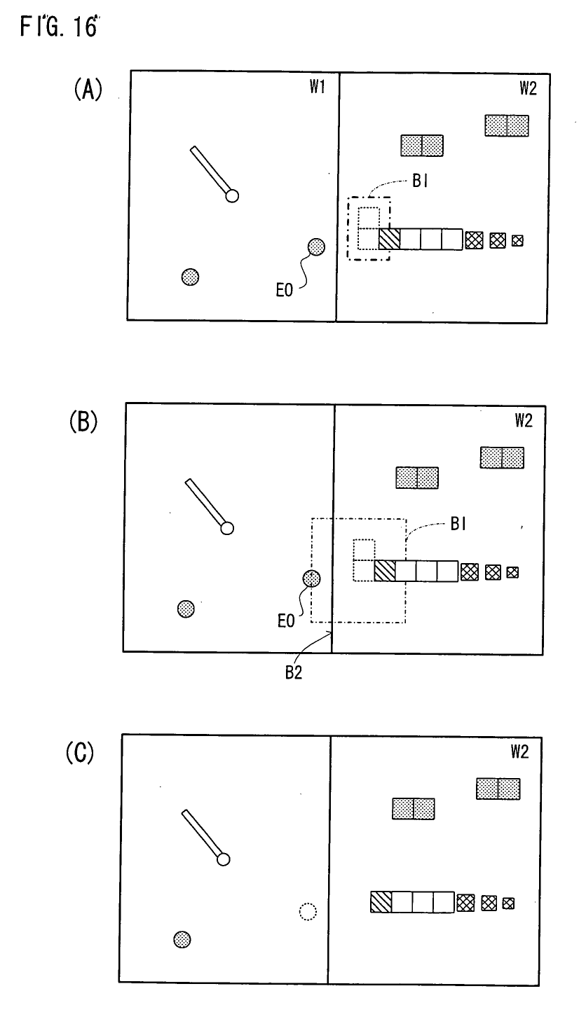

FIG. 16(A)-FIG. 16(C) show a further example of an influence exerted among the games. Referring to FIG. 16(A), the blast B1 caused by a flame of the enemy object EO shown in FIG. 13(C) diffuses into the second game across the boarder B2 between the windows W3 and W2. Within the game screen of the second game, an enemy object EO exists in the vicinity of the boarder B2, and the blast B1 reaches the enemy object EO. Referring to FIG. 16(C), the enemy object EO bursts into flames due to the blast B1, and destroyed by fire.

Here, a magnitude relation among the three windows W1-W3 and a positional relation among the three windows W1-W3 in the vertical direction (Y direction) are changed according to the progress of the three game processing. More specifically, the magnitude relation among the windows are changed depending on a difference of scales among the game processing, and the positional relation (vertical relationship of barycenter positions) between the windows are changed depending on the difference of stages among the game processing. It should be noted that when the magnitude relation is changed, the total width of the three windows remains constant.

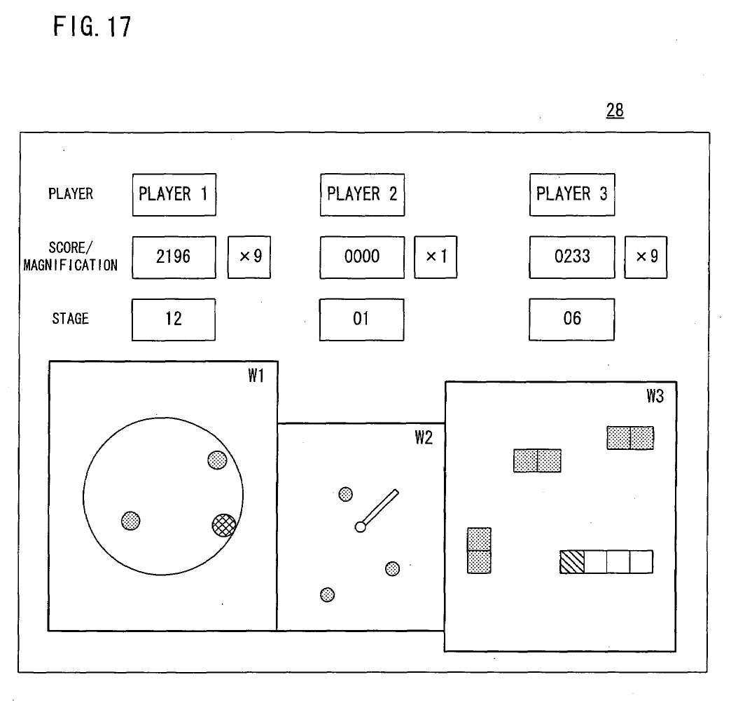

FIG. 17 shows one example of a game screen in a case that the scores, magnifications and stages are different among three games. With reference to FIG. 17, since the scale is “9” in each of the first game (W1) and the third game (W3), and “1” in the second game, the windows W1 and W3 are the same size, and the window W2 is smaller than them. Since the stage is respectively “12”, “01” and “06” in the first to third games, the window W1 is at a position the highest in barycenter, the window W3 is at a position the second highest in barycenter, and the window W2 is a position the lowest of the three.

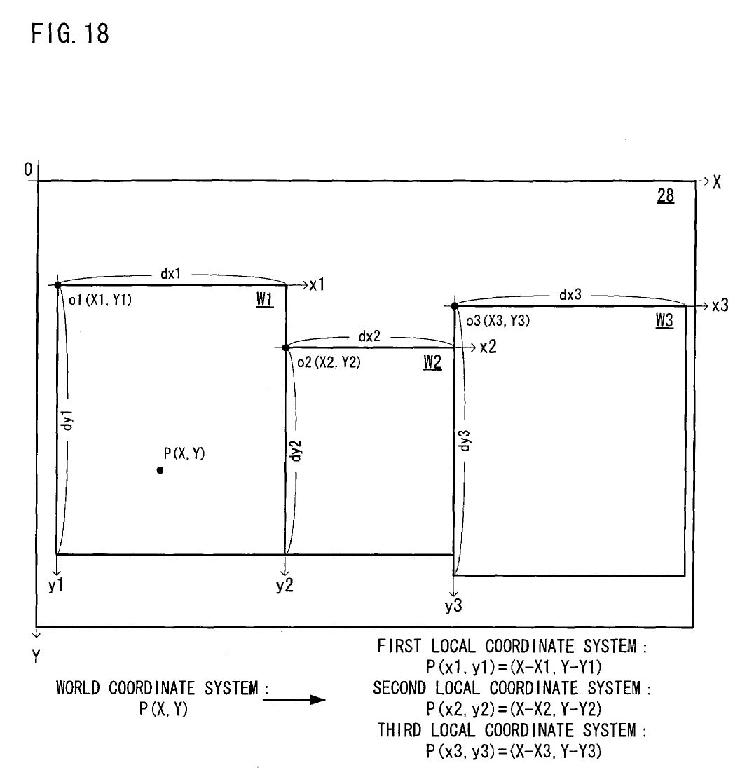

In the parallel game described above, a world coordinate system and first to third, that is, three local coordinate systems are utilized as shown in FIG. 18. Referring to FIG. 18, a world coordinate system (X-Y coordinate system) taking the upper left edge of the game screen as an origin point O with respect to an arbitrary point P on the game screen (28) is defined as “P (X,Y)”. With respect to the game space of the first game, a first local coordinate system (x1-y1 coordinate system) taking the upper left edge of the window W1 as an origin point o1 is defined, and described like “P (x1, y1)”. Similarly, with respect to the game space of the second game, a second local coordinate system (x2-y2 coordinate system) taking the upper left edge of the window W2 as an origin point o2 is defined, and described like “P (x2, y2)”. Then, with respect to the game space of the third game, a third local coordinate system (x3-y3 coordinate system) taking the upper left edge of the window W3 as an origin point o3 is defined, and described as “P(x3, y3)”.

When the world coordinate system with the origin point o1 is (X1, Y1), a following equation (1) is established between (X, Y) and (x1, y1).

(x1,y1)=(X−X1,Y−Y1) (1)

When the world coordinate system with the origin point o2 is (X2, Y2), a following equation (2) is established between (X, Y) and (x2, y2).

(x2,y2)=(X−X2,Y−Y2) (2)

When the world coordinate system with the origin point o3 is (X3, Y3), a following equation (3) is established between (X, Y) and (x3, y3).

(x3,y3)=(X−X3,Y−Y3) (3)

Furthermore, the size of the window W1 is described like “dx1×dy1”, the size of the window W2 is described like “dx2×dy2”, and the size of the window W3 is described like “dx3×dy3”.

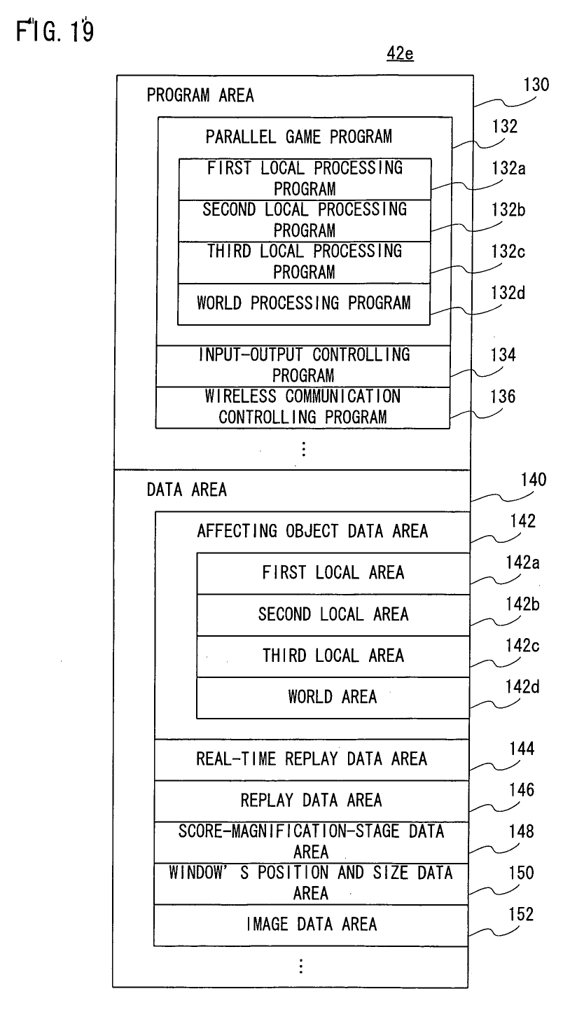

FIG. 19 shows a memory map of the internal main memory 42e in a case that a parallel game is executed. With reference to the FIG. 19, the main memory 42e includes a program area 130 and a data area 140. A part of the program and the data are read from the optical disk 22 or the flash memory 44 entirely at a time, or partially and sequentially as necessary so as to be stored into the internal main memory 42e, and then processed in the CPU 40 and the GPU 42b, the DSP 42c, etc. within the system LSI 42. It should be noted that in FIG. 19, only a part of the memory map is shown and other programs and data required for the processing are stored.

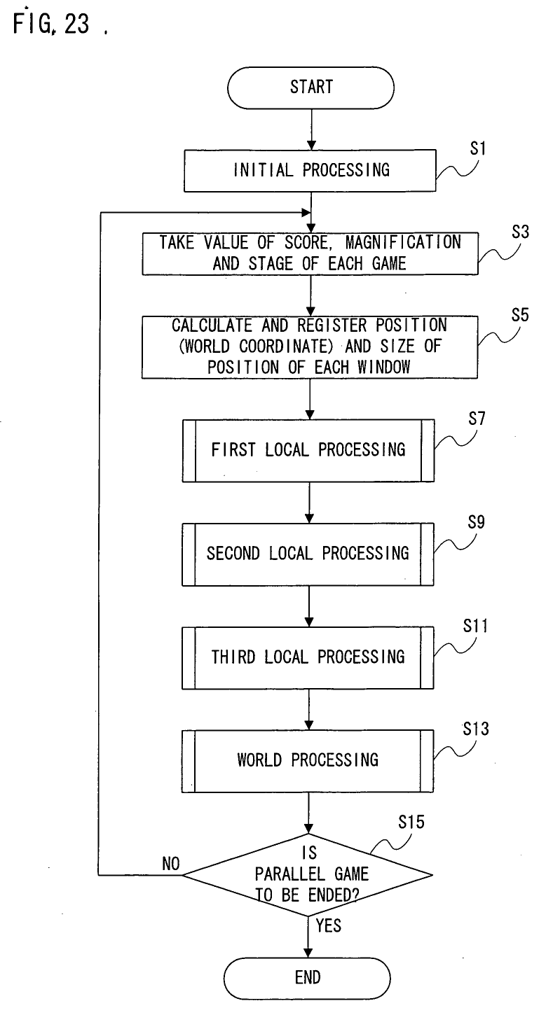

In the program area 130, a parallel game program 132, an input-output controlling program 134, a communication controlling program 136, etc. are stored. The parallel game program 132 is a program for realizing the above-described parallel game, and corresponds to a flowchart (main routine) shown in FIG. 23.

The parallel game program 132 includes first-third local processing programs 132a-132c and a world processing program 132d as subroutines. The first-third local processing programs 132a-132c are programs for realizing the first-third games (the game screens are shown on the windows W1-W3: see FIG. 9), and correspond to steps S7-S11 shown in FIG. 23. The world processing program 132d is a program for performing an entire control and linking among the first-third games, and corresponds to a step S13 in FIG. 23. It should be noted that the rest of steps in FIG. 23, that is, steps S1-S5 and S15 are taken charge by the parallel game program 132.

The input-output controlling program 134 is a program for mainly controlling the input-output processor 42a. The input-output processor 42a writes operation data from the controller 14 to a real-time playing data area 144 of the internal main memory 42e according to this program, for example.

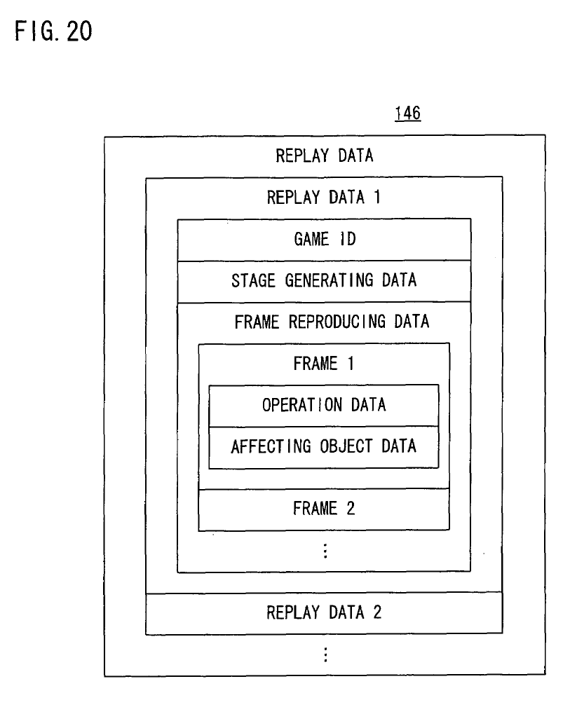

The wireless communication controlling program 136 is a program for mainly controlling the wireless communication module 50a. The wireless communication module 50a transmits and receives replay data (see FIG. 20) with another game apparatus 12 according to this program. Here, transmitting and receiving the replay data is performed through electronic mail.

The data area 140 includes an affecting object data area 142, a real-time replay data area 144, a replay data area 146, a score-magnification-stage data area 148, a window's position and size data area 150, an image data area 152, etc.

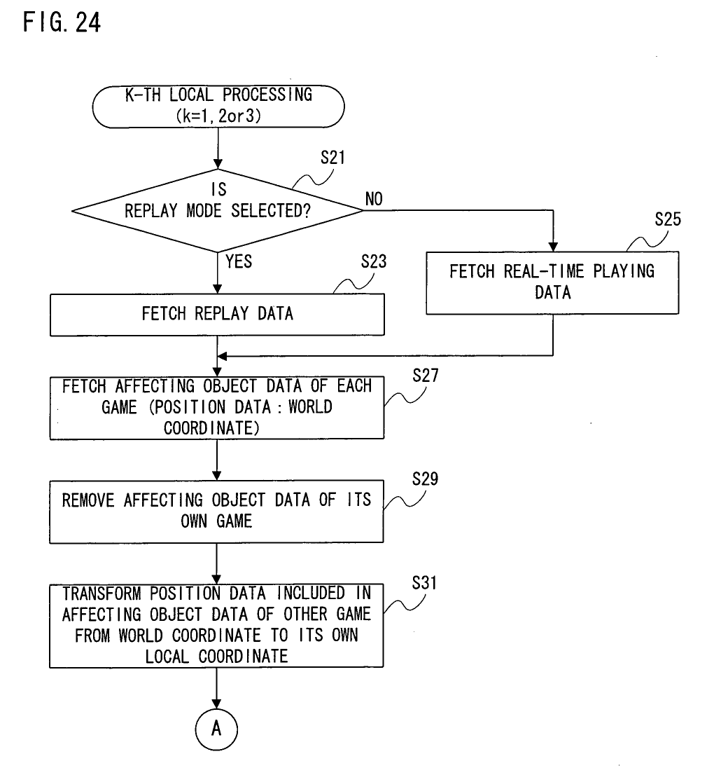

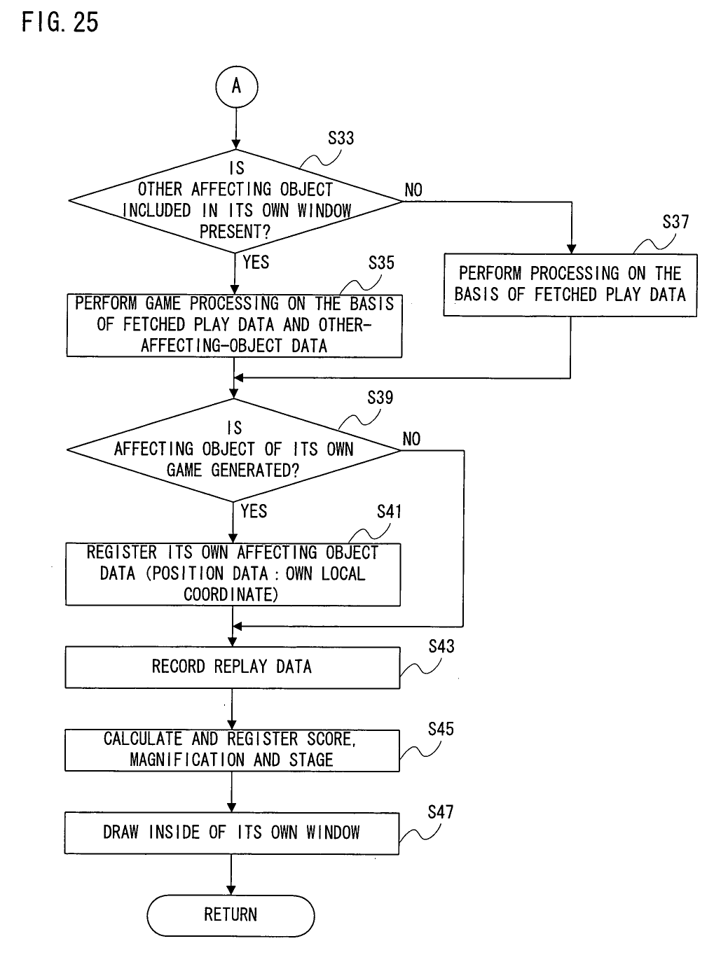

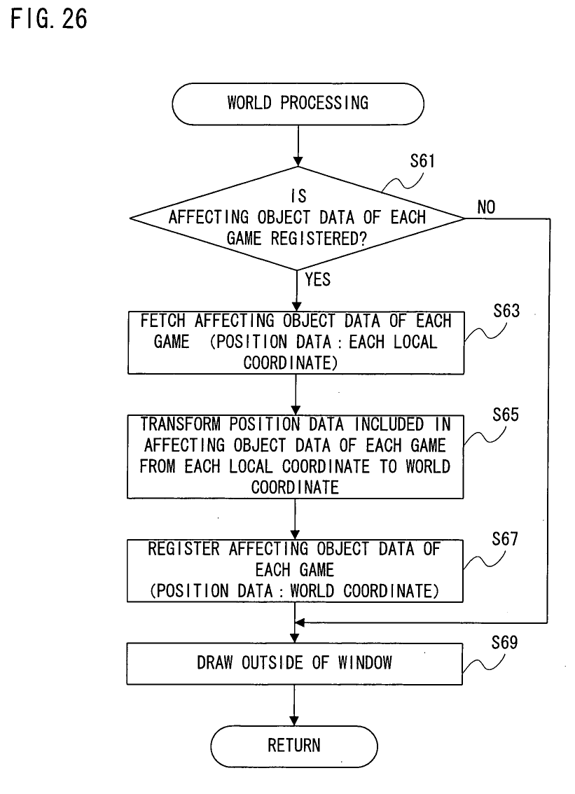

The affecting object data area 142 includes first-third local areas 142a-142c respectively assigned to the first-third local processing (see FIG. 24 and FIG. 25), and a world area 142d assigned to the world processing (see FIG. 26).

The real-time playing data area 144 is an area for temporarily storing real-time playing data, that is, operation data (current operation data) output from the controller 14 in real time. The replay data area 146 is an area for storing replay data (past operation data) read from the flash memory 44, etc. The score-magnification-stage data area 148 is an area for storing data indicating values of the score, magnification and stage which are calculated by the first-third local processing. The window's position and size data area 150 is an area for storing origin positions and sizes (see FIG. 18) of the windows W1-W3 calculated by the main routine. The image data area 152 is an area for storing image data, etc. for drawing an object and a background at the outside and inside of the window.

FIG. 20 shows structure of replay data. Referring to FIG. 20, the replay data includes replay data 1 corresponding to one play and replay data 2 corresponding to another play, etc. Each of the replay data 1, 2, etc. includes a game ID, stage generating data and frame reproducing data. The frame reproducing data includes frame 1 data corresponding to a frame 1, frame 2 data corresponding to a frame 2, etc. Each of the frame 1 data, frame 2 data, etc. includes operation data and affecting object data.

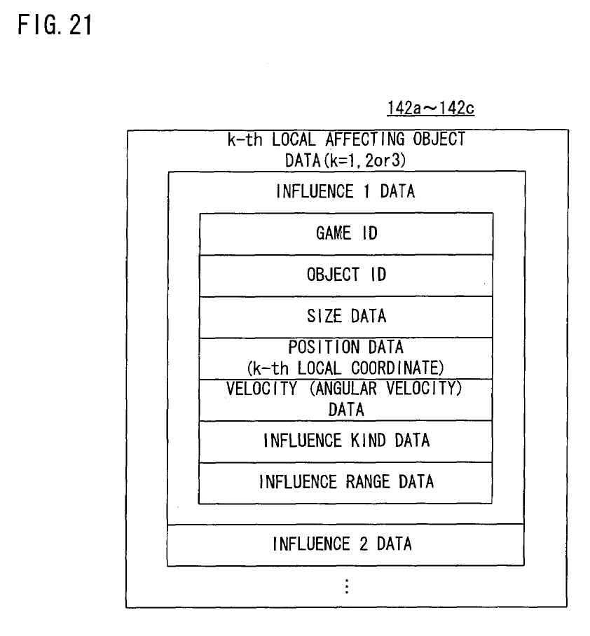

Next, FIG. 21 shows structure of k-th local affecting object data (k=1, 2 or 3). The k-th local affecting object data includes a game ID, an object ID, size data, position data, velocity (angular velocity) data, influence kind data and influence range data with respect to each of influence 1, influence 2, etc. Here, the position data is according to a k-th local coordinate system.

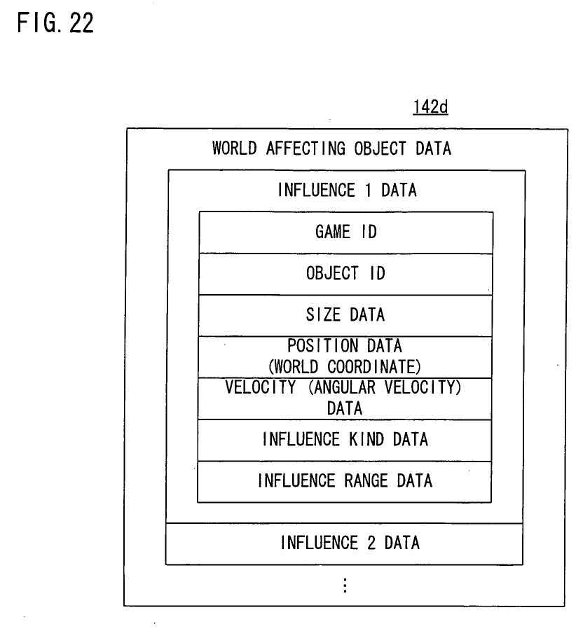

FIG. 22 shows structure of world affecting object data. The world affecting object data also includes a game ID, an object ID, size data, position data, velocity (angular velocity) data, influence kind data and influence range data with respect to each of influence 1, influence 2, etc. Here, the position data is according to the world coordinate system.

The CPU 40 executes processing according to a flowchart shown in FIG. 23 on the basis of the parallel game program 132 stored in the program area 130. Referring to FIG. 23, the CPU 40 first executes initial processing in a step S1. The initial processing includes processing of initializing data area 140, processing of displaying an initial screen on the monitor 28, processing of accepting a mode selection operation by the controller 14, processing of transferring replay data to the replay data area 146 of the internal main memory 42e from the flash memory 44 when a replay mode is selected, and processing of setting various initial values.

After completion of the initial processing, the CPU 40 takes values of the score, the magnification and the stage for each game from the score-magnification-stage data area 148 in a step S3. In a step S5, on the basis of the taken values, a position and a size of each of the windows W1-W3 is calculated, and the resultant is registered in the window's position and size data area 150. Here, the position of each of the windows W1-W3 is described in the world coordinate system with the above-described origin points o1-o3 (see FIG. 18 and the foregoing equations (1)-(3)).

After completion of registering the positions and the sizes, the process by the CPU 40 enters a loop from steps S7 to S15. It should be noted that the loop processing is executed for each frame (at a cycle of 1/60 seconds, for example). In the step S7, first local processing corresponding to the first game (W1: see FIG. 9) is executed, in the step S9, second local processing corresponding to the second game (W2) is executed, and in the step S11, third local processing corresponding to the third game (W3) is executed.

After such processing for each game, the CPU 40 executes world processing in the step S13. The first-third games are associated with each other through the world processing. In the step S15, it is determined whether or not the parallel game is to be ended, and if the determination result is “NO”, the process returns to the step S3.

The first-third local processing in the above-described step S7-S15, that is, “k-th” local processing (k=1, 2 or 3) is specifically according to a flowchart shown in FIG. 24 and FIG. 25. First, referring to FIG. 24, it is determined whether or not a replay mode is selected in a step S21. Here, mode information (not illustrated) indicating a result of the mode selection operation is stored in the flash memory 44, etc. If the determination result in the step S21 is “YES”, the process shifts to a step S23 to fetch replay data from the replay data area 146 while if the determination result in the step S21 is “NO”, the process shifts to a step S25 to fetch real-time playing data from the real-time playing data area 144.

The CPU 40 then shifts to a step S27 to fetch world affecting object data (see FIG. 22) from the world area 142d. Here, as described above, in the world affecting object data, information relating an affecting object generated in each of the games (including position data according to world coordinates) is described.

In a next step S29, a part relating to the affecting object of its own game, that is, the k-th game is removed from the world affecting object data taken in the step S27. In a succeeding step S31, transformation processing from the world coordinate system to the k-th local coordinate system is performed on the position data included in the removal result, that is, affecting object data of the other games. The transformation processing is executed on the basis of the above-described Equations (1)-(3). Then, the process proceeds to a step S33.

Referring to FIG. 25, in the step S33, it is determined whether or not an affecting object (other-affecting-object) generated in the other games is present within the own window Wk, and if the result is “YES”, the process proceeds to a step S35 while if the result is “NO”, the process proceeds to a step S37. That is, it is determined whether or not the local coordinates transformed in the step S31 are within the range of the window. In the step S35, game processing on the basis of the play data taken in the step S23 or S25 and the other-affecting-object data after the transformation processing in the step S31 is executed. In the step S37, game processing on the basis of only the taken play data is executed. The game processing is different depending on the kind of the game described above.

Here, detailed example of the game processing in the steps S35 and S37 is described. For example, since FIG. 14(A)-FIG. 14(C) show that the second game (W2) affects the first game (W1), the step S35 is executed in the first local processing, and the step S37 is executed in the second local processing. The affecting object in this case is an enemy object EO generated within the window W2 by the second game. The enemy object EO is flipped by the stick S across the boarder B1 and enters into the window W1.

The game processing is executed on the basis of the real-time playing data and the replay data to determine a position and a state of each of the objects. If the game processing is executed on the basis of the replay data, operation data of a corresponding frame in the replay data is read for each frame, and by performing processing similar to that when the operation data is input by the operation of the user, a past play is reproduced. In addition, since an affecting object from other game in the past play cannot be reproduced from only the operation data, affecting object data corresponding to the frame is read to reproduce the affecting object and its influence in the past play.

Additionally, the size and velocity of this enemy object EO for display are not changed before and after crossing of the boarder. Even if the magnitude relation and the positional relation among the windows are changed, the size and velocity of the enemy object EO are maintained. Thus, if the window is a small state, relatively much influence is exerted thereon.

It should be noted that since in the first game (W1) and the second game (W2), local coordinates which are different from each other are utilized (see FIG. 18), coordinate transformation processing has to be performed on the position data. The coordinate transformation processing includes two transformation processing of first transformation processing from the second local coordinate system to the world coordinate system and second transformation processing from the world coordinate system to the first local coordinate system.

That is, second local affecting object data (see FIG. 21) is first passed from the second local processing (S5) as a source of the influence to the world processing (S9) to allow the world processing to perform the first transformation processing on the position data (S65: described later). Next, the result of the first transformation processing, that is, world affecting object data (see FIG. 22) is passed from the world processing to the first local processing as an affecting destination to allow the first local processing to perform second transformation processing on the position data (S31). Thus, it is possible to transmit an influence between the first-third local processing.

After such game processing, the CPU 40 shifts to the step S35 to determine whether or not an affecting object of its own game, that is, the k-th game is generated by the game processing. If this determination result is “YES”, k-th local affecting object data (see FIG. 21) is registered in the k-th local area (142a-142c) in a step S41, and then, the process proceeds to a step S43. On the other hand, if the determination result is “NO”, the process directly proceeds to the step S43.

In the step S43, operation data in a current frame, that is, real-time playing data is recorded as replay data in the replay data area 146. In addition, in a case that an affecting object of other game is included in the own window, information on the affecting object is also recorded in the replay data area 146. In a succeeding step S45, values of the score, the magnification and the stage are calculated on the basis of the result of the game processing to register the same in the score-magnification-stage data area 148. Then, in a step S47, a drawing the own window Wk is performed on the basis of the result of the game processing and the calculation result. In the drawing processing, the data of the window's position and size data area 150 and the data of the image data area 152 are utilized. After the drawing, the process is restored to the main routine. Here, since the position and size of the object within the own game are defined by the local coordinate system, if the window is large, a larger object for display is drawn.

The k-th local processing as described above is performed by the number of games which is being executed. It should be noted that although k=3 in this embodiment, k is not limited to 3, and can arbitrarily be set depending on the number of games that are simultaneously executed, that is, the number of windows.

The world processing in the foregoing step S13 is specifically according to a flowchart shown in FIG. 26. Referring to FIG. 26, the CPU 40 determines whether or not affecting object data of each game, that is, the first to k-th local affecting object data (see FIG. 21) is registered in the affecting object data area 142 in a step S61. If this determination result is “YES”, a series of processes in steps S63-S67 are executed and then, the process proceeds to a step S69, and if “NO”, the process directly proceeds to the step S69.

In the step S63, affecting object data of each game is fetched from the affecting object data area 142, and in the step S65, a transformation from each of the local coordinate system to the world coordinate system is performed on the position data included in the fetched data. In the step S67, affecting object data including the position data after the coordinate transformation, that is, world affecting object data (see FIG. 22) is registered in the world area 142d, and in the step S69, drawing a part outside the windows W1-W3 is performed. In the drawing processing, the data of the window's position and size data area 150 and the data of the image data area 152 are utilized. Then, the process is restored to a main routine.

As understood from the above description, in this embodiment, the game apparatus 12 can simultaneously execute the first to third game processing. The CPU 40 of the game apparatus 12 executes the first game processing on the basis of the first operation data and displays the resultant on the window W1 (S7), executes the second game processing on the basis of the second operation data and displays the resultant on the window W2 (S9), and executes the third game processing on the basis of the third operation data and displays the resultant on the window W3 (S1).

At this time, the CPU 40 exerts an influence on the basis of the execution result of the first game processing on the window W2 on which the execution result of the second game processing is displayed and on the window W3 on which the execution result of the third game processing is displayed, exerts an influence on the basis of the execution result of the second game processing on the window W3 on which the execution result of the third game processing is displayed and on the window W1 on which the execution result of the first game processing is displayed, and exerts an influence on the basis of the execution result of the third game processing on the window W1 on which the execution result of the first game processing is displayed and on the window W2 on which the execution result of the second game processing is displayed. Thus, an influence of any one of the first-third game processing is exerted on another arbitrary game.

Here, each of the windows W1-W3 is an area arranged within the screen of the monitor 28. The screen of the monitor 28 is brought into association with the world coordinate system (X-Y coordinate system). The window W1 is brought into association with the first local coordinate system (x1-y1 coordinate system), the window W2 is brought into association with the second local coordinate system (x2-y2 coordinate system), and the window W3 is brought into association with the third local coordinate system (x3-y3 coordinate system).

Furthermore, the execution result of the first processing step includes position data of the first affecting object to be displayed on the window W2 and/or W3, the execution result of the second processing step includes position data of the second affecting object to be displayed on the window W3 and/or W1, and the execution result of the third processing step includes position data of the third affecting object to be displayed on the window W1 and/or W2.

The CPU 40 performs the first transformation processing from the first local coordinate system to the world coordinate system on the position data of the first affecting object (S65), and then performs the second transformation processing from the world coordinate system to the second coordinate system on the position data after the first transformation processing (S31). Similar transformation processing is performed on each of the position data of the second and third objects. Thus, it becomes possible to exert an influence among the game processing according to different local coordinate systems.

In this embodiment, at least one of the first-third operation data is real-time operation data on the basis of a current operation, and the rest of them are replay operation data on the basis of a past operation. Thus, the player can play with a player who existed in the past. The past operation may be an operation of the player himself or herself, and in this case, the player can play a game with him himself in the past. Also, the player can advance a current game so as to advantageously make a game play in the future, capable of heighten a strategic characteristic of this game.

In addition, although the first to third three game processing is simultaneously executed in this embodiment, the game processing to be simultaneously executed may be two or equal to or more than four.

Furthermore, in this embodiment, the real-time operation data is utilized in the game system 10 (game apparatus 12), but it may be transmitted and received with another game system 10 (game apparatus 12) via the communication system 120.

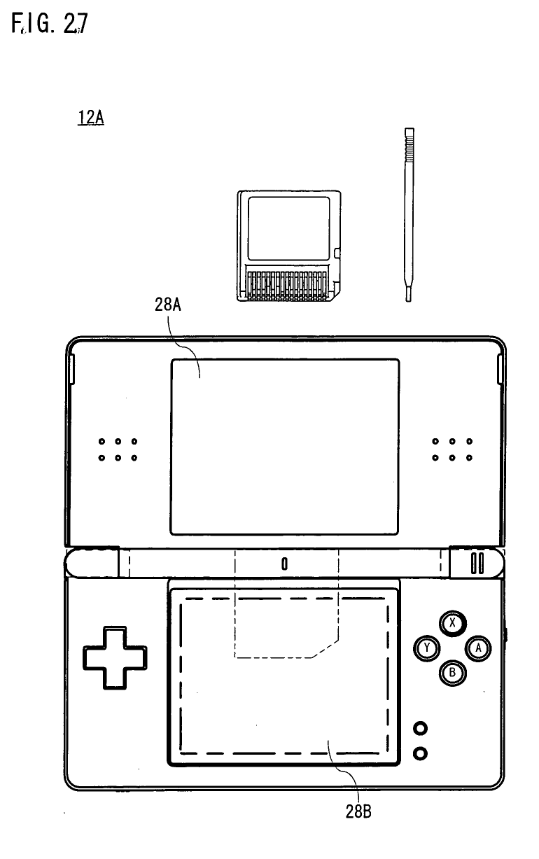

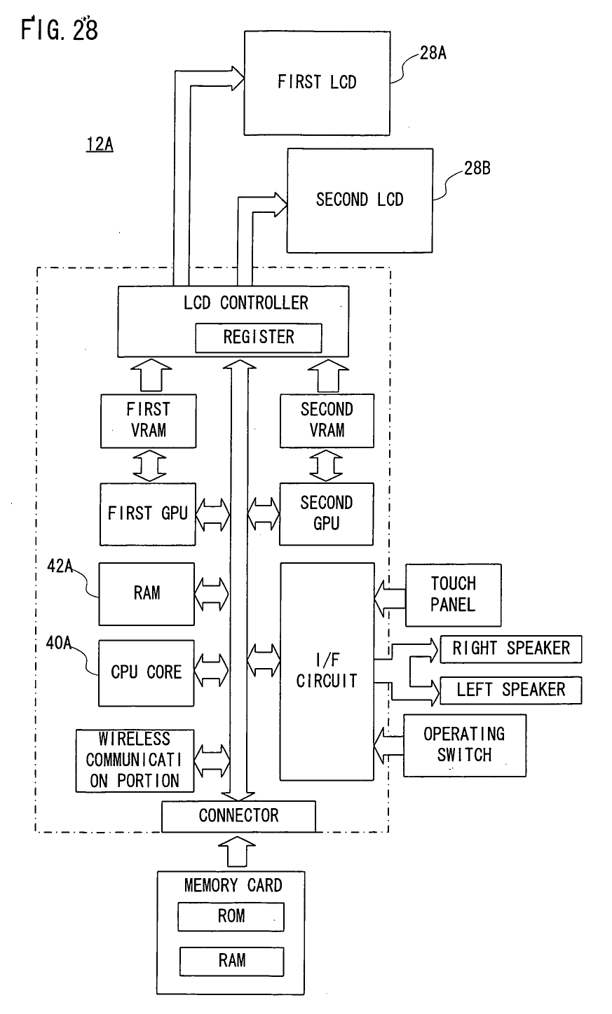

In addition, in this embodiment, the result of the first game processing and the result of the second game processing are respectively displayed on the two windows W1 and W2 within the single screen (28), but may be displayed on the two screens. FIG. 27 and FIG. 28 show one example of a game apparatus with two screens. Referring to FIG. 27 and FIG. 28, in a game apparatus 12A, a CPU core 40A corresponds to the CPU 40 in the previous embodiment, and a RAM 42A corresponds to the internal main memory 42e in the previous embodiment. A result of first game processing (displayed content of the window W1) is displayed on a first LCD 28A, and a result of second game processing (W2) is displayed on a second LCD 28B. That is, drawing processing (S47) in the first local processing (see FIG. 24 and FIG. 25) is performed on the first LCD 28A, and drawing processing (S47) in the second local processing (see FIG. 24 and FIG. 25) is performed on the second LCD 28B.

In this case, for example, the first LCD 28A and the second LCD 28B are arranged on a virtual plane (corresponding to the screen of the monitor 28) to which a world coordinate system (X-Y coordinate system) is assigned, and a first local coordinate system (x1-y1 coordinate system) and a second local coordinate system (x2-y2 coordinate system) are respectively assigned to the first LCD 28A and the second LCD 28B (corresponding to the windows W1 and W2) (see FIG. 18: Noted that the size of the LCD may be common). Thus, it is possible to exert an influence between the first game processing and the second game processing like the previous embodiment. In addition, there is a method of assigning a common coordinate system, that is, a world coordinate system to the first LCD 28A and the second LCD 28B as another example.

Although the game system 10 is explained as one example in the above description, this invention can be applied to a processing system or a processing apparatus (hand-held mobile phone terminal, personal computer, etc.) capable of executing a plurality of game processing in parallel.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A recording medium recording a game program to be executed by a computer of a game apparatus to display a game screen corresponding to game processing on a display area of a display,
said game program causes said computer to execute:
a display area setting step for setting at least two areas of a first area for displaying a game space of a first game and a second area for displaying a game space of a second game on said display area, and defining a first local coordinate system in the game space of said first area and a second local coordinate system in the game space of said second area;
a second game processing step for performing predetermined game processing in said second game to decide coordinates in said second local coordinate system as to a second game object being a predetermined object within the game space;
a first position transforming step for transforming the position of said second game object in said second local coordinate system into a position in a world coordinate system to be defined on the display area;
a second position transforming step for transforming the position of said second game object in said world coordinate system into a position in said first local coordinate system;
a determining step for determining the position of said second game object is at said first area;
a first game processing step for performing game processing such that said first game is affected by said second game object which is determined to be at said first area by said determining step on the basis of the position in said first local coordinate system; and
a displaying step for displaying the game space of said first game at said first area and the game space of said second game at said second area.

2. A recording medium recording a game program according to claim 1, wherein
said display area setting step changes at least one of a positional relation between said first area and said second area and a magnitude relation between said first area and said second area on the basis of an execution result of said first game processing step and an execution result of said second game processing step, and changes a corresponding relation between said first and second local coordinates and said world coordinate in accordance with said change.

3. A recording medium recording a game program according to claim 1, wherein
the game processing in said first game processing step is executed on the basis of first operation data for a game operation, and
the game processing in said second game processing step is executed on the basis of second operation data for a game operation.

4. A recording medium recording a game program according to claim 3, wherein
said first operation data is real-time operation data to be input by a user's operation, and said second operation data is replay operation data stored in a storage medium for advancing a game in place of the user's operation.

5. A recording medium recording a game program according to claim 4, wherein
said program causes said computer to further execute a storing step for storing said real-time operation data as said replay operation data in said storage medium.

6. A recording medium recording a game program according to claim 5, wherein
said program causes said computer to further execute a communicating step for transmitting and receiving replay operation data with other game apparatus via a communication means.

7. A recording medium recording a game program according to claim 1, wherein
said display area further comprises a first screen and a second screen, and
said first area and said second area respectively correspond to said first screen and said second screen.

8. A recording medium recording a game program according to claim 1, wherein
said first game processing step further decides coordinates in said first local coordinate system as to a first game object being a predetermined object within a game space,
said first position transforming step further transforms the position of said first game object in said first local coordinate system into a position in a world coordinate system defined on the display area,
said second position transforming step further transforms the position of said first game object in said world coordinate system into a position in said second local coordinate system,
said determining step further determines the position of said first game object is at said second area, and
said second game processing step further executes performing game processing such that said second game is affected by said first game object which is determined to be at said second area by said determining step on the basis of the position in said second local coordinate system.

9. A recording medium recording a game program according to claim 8, wherein
said display area setting step further sets a k-th area for displaying a game space of a k-th (k is a natural numeral equal to or more than three) game on said display area, and defines a k-th local coordinate system at the k-th area in the game space, and
said game program causes said computer to further execute k-th game processing step for performing predetermined game processing in said k-th game.

10. A game apparatus displaying a game screen corresponding to game processing on a display area, comprising:
a display area setting means for setting at least two areas of a first area for displaying a game space of a first game and a second area for displaying a game space of a second game on said display area and respectively defining the game spaces as first and second local coordinate systems;
a second game processing means for performing predetermined game processing in said second game to decide coordinates in said second local coordinate system as to a second game object being a predetermined object within the game space;
a first position transformation means for transforming the position of said second game object in said second local coordinate system into a position in a world coordinate system to be defined on the display area;
a second position transforming means for transforming the position of said second game object in said world coordinate system into a position in said first local coordinate system;
a determining means for determining the position of said second game object is at said first area;
a first game processing means for performing game processing such that said second game is affected by said second game object which is determined to be at said first area by said determining means on the basis of the position in said first local coordinate system; and
a displaying means for displaying the game space of said first game at said first area and the game space of said second game at said second area.

11. A recording medium recording a game program, wherein
said game program causes a computer of a processing apparatus capable of executing a plurality of game processing in parallel to execute:
a first processing step for executing first game processing as one of said plurality of game processing on the basis of first operation data and displaying a execution result at a first area;
a second processing step for executing second game processing as another one of said plurality of game processing on the basis of second operation data and displaying an execution result at a second area; and
an affecting step for exerting an influence on the basis of the execution result of said first game processing by said first processing step on the second area at which the execution result of said second game processing by said second processing step is displayed.

12. A recording medium recording a game program according to claim 11, wherein
each of said first area and said second area is a part of a common screen,
said common screen is brought into association with a world coordinate system,
said first area is brought into association with a first local coordinate system, and
said second area is brought into association with a second local coordinate system.

13. A recording medium recording a game program according to claim 12, wherein
the execution result of said first processing step includes position data of an affecting object to be displayed on said second area,
said affecting step includes a first transforming step for performing first transformation processing from said first local coordinate system to said world coordinate system on said position data, and
a said second processing step includes a second transforming step for performing second transformation processing from said world coordinate system to said second coordinate system on said position data after said first transformation processing.

14. A recording medium recording a game program according to claim 11, wherein
said program causes said computer to execute a changing step for changing at least one of a positional relation between said first area and said second area and a magnitude relation between said first area and said second area on the basis of the execution result by said first processing step and the execution result by said second processing step.

15. A recording medium recording a game program according to claim 11, wherein
one of said first operation data and said second operation data is real-time operation data on the basis of a current operation, and the other one of said first operation data and said second operation data is replay operation data on the basis of a past operation.

16. A recording medium recording a game program according to claim 15, wherein
said current operation and said past operation are operations by a common player.

17. A recording medium recording a game program according to claim 15, wherein
said program causes said computer to further execute a recording step for recording said real-time operation data as said replay operation data.

18. A recording medium recording a game program according to claim 17, wherein
said processing apparatus transmits the replay operation data recorded by said recording step to other processing apparatus via a communication means, and receives other replay operation data from said other processing apparatus via said communication means.

19. A recording medium recording a game program according to claim 11, wherein
said first game processing and said second game processing are processing according to rules being different from each other.

20. A recording medium recording a game program according to claim 11, wherein
said first game processing and said second game processing are processing according to a common game rule.
